(19) United States
(12) Patent Application Publication
(10) Pub. No.: US 2025/0330599 A1
(43) Pub. Date: Oct. 23, 2025

(54) METHOD AND APPARATUS FOR DYNAMIC MESH BASE GEOMETRY CODING SIGNALING FOR LIFTING PARAMETERS

(71) Applicant: GUANGDONG OPPO MOBILE TELECOMMUNICATIONS CORP., LTD., Dongguan (CN)

(72) Inventors: Vladyslav ZAKHARCHENKO, Palo Alto, CA (US); Haoping YU, Palo Alto, CA (US); Yue YU, Palo Alto, CA (US)

(21) Appl. No.: 19/182,794

(22) Filed: Apr. 18, 2025

Related U.S. Application Data
(60) Provisional application No. 63/637,216, filed on Apr. 22, 2024.

(51) Int. Cl. H04N 19/12; G06T 9/00; H04N 19/169; H04N 19/70

(52) U.S. Cl. CPC H04N 19/12; G06T 9/001; H04N 19/1883; H04N 19/70

(57) ABSTRACT

According to one aspect, a method of decoding is provided. The method may include decoding a first syntax element to determine which type of lifting transform is enabled. The method may include, in response to a linear lifting transform being enabled, decoding a second syntax element to determine whether a lifting offset applied to lifting transform values is enabled. The method may include, in response to the lifting offset applied to the lifting transform values being enabled, decoding a third syntax element to determine a lifting offset numerator value. The method may include, in response to the lifting offset applied to the lifting transform values being enabled, decoding a fourth syntax element to determine a lifting offset denominator value. The method may include, in response to the lifting offset applied to the lifting transform values being enabled, decoding a bitstream based on the lifting offset numerator value and denominator value.

### CROSS-REFERENCE TO RELATED APPLICATION

This application claims the benefit of priority to U.S. Provisional Application No. 63/637,216, filed Apr. 22, 2024, entitled “DYNAMIC MESH BASE GEOMETRY CODING SIGNALING FOR LIFTING PARAMETERS,” which is incorporated herein by reference in its entirety.

### BACKGROUND

Embodiments of the present disclosure relate to dynamic mesh coding.

A mesh is composed of a collection of vertices, edges, and faces that defines the shape, or topology of a polyhedral object. The faces usually consist of triangles. Each vertex in the three-dimensional (3D) space is associated with a geometry position together with connectivity and attribute (e.g., color, reflectance, intensity, classification, etc.) or mapping and texture information. In order to compress the dynamic mesh data efficiently, the geometry of the mesh can be compressed first, and then the corresponding connectivity, attributes, and/or mapping can be compressed based upon the geometry information according to a dynamic mesh coding technique, e.g., such as versatile dynamic mesh coding (V-DMC).

### SUMMARY

According to one aspect of the present disclosure, a method of decoding by a decoder is provided. The method may include decoding, by a processor, a first syntax element to determine which type of lifting transform is enabled. The method may include, in response to a linear lifting transform being enabled, decoding, by the processor, a second syntax element to determine whether a lifting offset applied to lifting transform values is enabled. The method may include, in response to the lifting offset applied to the lifting transform values being enabled, decoding, by the processor, a bitstream based on the lifting offset applied to the lifting transform values.

According to another aspect of the present disclosure, a method of decoding by a decoder is provided. The method may include decoding, by a processor, a first syntax element. The method may include, in response to the first syntax element having a first value, determining, by the processor, a lifting offset value for each level-of-detail. The method may include decoding, by the processor, a bitstream based on the lifting offset value for each level of detail.

According to a further aspect of the present disclosure, a method of decoding by a decoder is provided. The method may include decoding, by a processor, a first syntax element. The method may, in response to the first syntax element having a first value and a linear lifting transform being enabled, decoding, by the processor, a second syntax element. The method may include, in response to the second syntax element having a second value, for a level-of-detail, decoding, by the processor, a third syntax element to determine a lifting offset numerator value. The method may include, in response to the second syntax element having a second value, for the level-of-detail, decoding, by the processor, a fourth syntax element to determine a lifting offset denominator value. The method may include, in response to the second syntax element having a second value, for the level-of-detail, decoding, by the processor, a bitstream based on the lifting offset numerator value and the lifting offset denominator value.

According to yet another aspect of the present disclosure, a decoder is provided. The decoder may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, decode a bitstream based on the lifting offset applied to the lifting transform values.

According to still a further aspect of the present disclosure, a decoder is provided. The decoder may include a processor and memory storing instructions. The memory storing instructions, which when executed by the processor, may cause the processor to decode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to decode a bitstream based on the lifting offset value for each level of detail.

According to another aspect of the present disclosure, a decoder is provided. The decoder may include a processor and memory storing instructions. The memory storing instructions, which when executed by the processor, may cause the processor to decode a first syntax element. The memory storing instructions, which when executed by the processor, may cause the processor to, in response to the first syntax element having a first value and a linear lifting transform being enabled, decode a second syntax element. The memory storing instructions, which when executed by the processor, may cause the processor to, in response to the second syntax element having a second value, for a level-of-detail, decode a third syntax element to determine a lifting offset numerator value. The memory storing instructions, which when executed by the processor, may cause the processor to, in response to the second syntax element having a second value, for the level-of-detail, decode a fourth syntax element to determine a lifting offset denominator value. The memory storing instructions, which when executed by the processor, may cause the processor to, in response to the second syntax element having a second value, for the level-of-detail, decode a bitstream based on the lifting offset numerator value and the lifting offset denominator value.

According to yet another aspect of the present disclosure, an apparatus for decoding is provided. The apparatus for decoding may include a processor and memory storing instructions. The memory storing instructions, which when executed by the processor, cause the processor to decode a first syntax element to determine which type of lifting transform is enabled. The memory storing instructions, which when executed by the processor, cause the processor to, in response to a linear lifting transform being enabled, decode a second syntax element to determine whether a lifting offset applied to lifting transform values is enabled. The memory storing instructions, which when executed by the processor, cause the processor to, in response to the lifting offset applied to the lifting transform values being enabled, decode a bitstream based on the lifting offset applied to the lifting transform values.

According to yet another aspect of the present disclosure, an apparatus for decoding is provided. The apparatus for decoding may include a processor and memory storing instructions. The memory storing instructions, which when executed by the processor, may cause the processor to decode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to decode a bitstream based on the lifting offset value for each level of detail.

According to yet another aspect of the present disclosure, an apparatus for decoding is provided. The apparatus for decoding may include a processor and memory storing instructions. The memory storing instructions, which when executed by the processor, may cause the processor to decode a first syntax element. The memory storing instructions, which when executed by the processor, may cause the processor to, in response to the first syntax element having a first value and a linear lifting transform being enabled, decode a second syntax element. The memory storing instructions, which when executed by the processor, may cause the processor to, in response to the second syntax element having a second value, for a level-of-detail, decode a third syntax element to determine a lifting offset numerator value. The memory storing instructions, which when executed by the processor, may cause the processor to, in response to the second syntax element having a second value, for the level-of-detail, decode a fourth syntax element to determine a lifting offset denominator value. The memory storing instructions, which when executed by the processor, may cause the processor to, in response to the second syntax element having a second value, for the level-of-detail, decode a bitstream based on the lifting offset numerator value and the lifting offset denominator value.

According to yet another aspect of the present disclosure, a non-transitory computer-readable medium storing instructions for a decoder is provided. The instructions, which when executed by the processor of the decoder, may cause the processor of the decoder to decode a first syntax element to determine which type of lifting transform is enabled. The instructions, which when executed by the processor of the decoder, may cause the processor of the decoder to, in response to a linear lifting transform being enabled, decode a second syntax element to determine whether a lifting offset applied to lifting transform values is enabled. The instructions, which when executed by the processor of the decoder, may cause the processor of the decoder to, in response to the lifting offset applied to the lifting transform values being enabled, decode a bitstream based on the lifting offset applied to the lifting transform values.

According to yet another aspect of the present disclosure, a non-transitory computer-readable medium storing instructions for a decoder is provided. The instructions, which when executed by the processor of the decoder, may cause the processor of the decoder to decode a first syntax element. The instructions, which when executed by the processor of the decoder, may cause the processor of the decoder to, in response to the first syntax element having a first value, determine a lifting offset value for each level-of-detail. The instructions, which when executed by the processor of the decoder, may cause the processor of the decoder to decode a bitstream based on the lifting offset value for each level of detail.

According to yet another aspect of the present disclosure, a non-transitory computer-readable medium storing instructions for a decoder is provided. The instructions, which when executed by the processor of the decoder, may cause the processor of the decoder to decode a first syntax element. The instructions, which when executed by the processor of the decoder, may cause the processor of the decoder to, in response to the first syntax element having a first value and a linear lifting transform being enabled, decode a second syntax element. The instructions, which when executed by the processor of the decoder, may cause the processor of the decoder to, in response to the second syntax element having a second value, for a level-of-detail, decode a third syntax element to determine a lifting offset numerator value. The instructions, which when executed by the processor of the decoder, may cause the processor of the decoder to, in response to the second syntax element having a second value, for the level-of-detail, decode a fourth syntax element to determine a lifting offset denominator value. The instructions, which when executed by the processor of the decoder, may cause the processor of the decoder to, in response to the second syntax element having a second value, for the level-of-detail, decode a bitstream based on the lifting offset numerator value and the lifting offset denominator value.

According to one aspect of the present disclosure, a method of encoding by an encoder is provided. The method may include encoding, by a processor, a first syntax element to determine which type of lifting transform is enabled. The method may include, in response to a linear lifting transform being enabled, encoding, by the processor, a second syntax element to determine whether a lifting offset applied to lifting transform values is enabled. The method may include, in response to the lifting offset applied to the lifting transform values being enabled, encoding, by the processor, a bitstream based on the lifting offset applied to the lifting transform values.

According to another aspect of the present disclosure, a method of encoding by an encoder is provided. The method may include encoding, by a processor, a first syntax element. The method may include, in response to the first syntax element having a first value, determining, by the processor, a lifting offset value for each level-of-detail. The method may include encoding, by the processor, a bitstream based on the lifting offset value for each level of detail.

According to a further aspect of the present disclosure, a method of encoding by an encoder is provided. The method may include encoding, by a processor, a first syntax element. The method may, in response to the first syntax element having a first value and a linear lifting transform being enabled, encoding, by the processor, a second syntax element. The method may include, in response to the second syntax element having a second value, for a level-of-detail, encoding, by the processor, a third syntax element to determine a lifting offset numerator value. The method may include, in response to the second syntax element having a second value, for the level-of-detail, encoding, by the processor, a fourth syntax element to determine a lifting offset denominator value. The method may include, in response to the second syntax element having a second value, for the level-of-detail, encoding, by the processor, a bitstream based on the lifting offset numerator value and the lifting offset denominator value.

According to yet another aspect of the present disclosure, an encoder is provided. The encoder may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, encode a bitstream based on the lifting offset applied to the lifting transform values.

According to still a further aspect of the present disclosure, an encoder is provided. The encoder may include a processor and memory storing instructions. The memory storing instructions, which when executed by the processor, may cause the processor to encode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to encode a bitstream based on the lifting offset value for each level of detail.

According to another aspect of the present disclosure, an encoder is provided. The encoder may include a processor and memory storing instructions. The memory storing instructions, which when executed by the processor, may cause the processor to encode a first syntax element. The memory storing instructions, which when executed by the processor, may cause the processor to, in response to the first syntax element having a first value and a linear lifting transform being enabled, encode a second syntax element. The memory storing instructions, which when executed by the processor, may cause the processor to, in response to the second syntax element having a second value, for a level-of-detail, encode a third syntax element to determine a lifting offset numerator value. The memory storing instructions, which when executed by the processor, may cause the processor to, in response to the second syntax element having a second value, for the level-of-detail, encode a fourth syntax element to determine a lifting offset denominator value. The memory storing instructions, which when executed by the processor, may cause the processor to, in response to the second syntax element having a second value, for the level-of-detail, encode a bitstream based on the lifting offset numerator value and the lifting offset denominator value.

According to yet another aspect of the present disclosure, an apparatus for encoding is provided. The apparatus for encoding may include a processor and memory storing instructions. The memory storing instructions, which when executed by the processor, cause the processor to encode a first syntax element to determine which type of lifting transform is enabled. The memory storing instructions, which when executed by the processor, cause the processor to, in response to a linear lifting transform being enabled, encode a second syntax element to determine whether a lifting offset applied to lifting transform values is enabled. The memory storing instructions, which when executed by the processor, cause the processor to, in response to the lifting offset applied to the lifting transform values being enabled, encode a bitstream based on the lifting offset applied to the lifting transform values.

According to yet another aspect of the present disclosure, an apparatus for encoding is provided. The apparatus for encoding may include a processor and memory storing instructions. The memory storing instructions, which when executed by the processor, may cause the processor to encode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to encode a bitstream based on the lifting offset value for each level of detail.

According to yet another aspect of the present disclosure, an apparatus for encoding is provided. The apparatus for encoding may include a processor and memory storing instructions. The memory storing instructions, which when executed by the processor, may cause the processor to encode a first syntax element. The memory storing instructions, which when executed by the processor, may cause the processor to, in response to the first syntax element having a first value and a linear lifting transform being enabled, encode a second syntax element. The memory storing instructions, which when executed by the processor, may cause the processor to, in response to the second syntax element having a second value, for a level-of-detail, encode a third syntax element to determine a lifting offset numerator value. The memory storing instructions, which when executed by the processor, may cause the processor to, in response to the second syntax element having a second value, for the level-of-detail, encode a fourth syntax element to determine a lifting offset denominator value. The memory storing instructions, which when executed by the processor, may cause the processor to, in response to the second syntax element having a second value, for the level-of-detail, encode a bitstream based on the lifting offset numerator value and the lifting offset denominator value.

According to yet another aspect of the present disclosure, a non-transitory computer-readable medium storing instructions for an encoder is provided. The instructions, which when executed by the processor of the encoder, may cause the processor of the encoder to encode a first syntax element to determine which type of lifting transform is enabled. The instructions, which when executed by the processor of the encoder, may cause the processor of the encoder to, in response to a linear lifting transform being enabled, encode a second syntax element to determine whether a lifting offset applied to lifting transform values is enabled. The instructions, which when executed by the processor of the encoder, may cause the processor of the encoder to, in response to the lifting offset applied to the lifting transform values being enabled, encode a bitstream based on the lifting offset applied to the lifting transform values.

According to yet another aspect of the present disclosure, a non-transitory computer-readable medium storing instructions for an encoder is provided. The instructions, which when executed by the processor of the encoder, may cause the processor of the encoder to encode a first syntax element. The instructions, which when executed by the processor of the encoder, may cause the processor of the encoder to, in response to the first syntax element having a first value, determine a lifting offset value for each level-of-detail. The instructions, which when executed by the processor of the encoder, may cause the processor of the encoder to encode a bitstream based on the lifting offset value for each level of detail.

According to yet another aspect of the present disclosure, a non-transitory computer-readable medium storing instructions for an encoder is provided. The instructions, which when executed by the processor of the encoder, may cause the processor of the encoder to encode a first syntax element. The instructions, which when executed by the processor of the encoder, may cause the processor of the encoder to, in response to the first syntax element having a first value and a linear lifting transform being enabled, encode a second syntax element. The instructions, which when executed by the processor of the encoder, may cause the processor of the encoder to, in response to the second syntax element having a second value, for a level-of-detail, encode a third syntax element to determine a lifting offset numerator value. The instructions, which when executed by the processor of the encoder, may cause the processor of the encoder to, in response to the second syntax element having a second value, for the level-of-detail, encode a fourth syntax element to determine a lifting offset denominator value. The instructions, which when executed by the processor of the encoder, may cause the processor of the encoder to, in response to the second syntax element having a second value, for the level-of-detail, encode a bitstream based on the lifting offset numerator value and the lifting offset denominator value.

According to another aspect of the present disclosure, a method of decoding by a decoder is provided. The method may include decoding, by a processor, a first syntax element to determine which type of lifting transform is enabled. The method may include, in response to a linear lifting transform being enabled, decoding, by the processor, a second syntax element to determine whether a lifting offset applied to lifting transform values is enabled. The method may include in response to the lifting offset applied to the lifting transform values being enabled, for a level-of-detail, decoding, by the processor, a third syntax element to determine a lifting offset numerator value. The method may include in response to the lifting offset applied to the lifting transform values being enabled, for a level-of-detail, decoding, by the processor, a fourth syntax element to determine a lifting offset denominator value. The method may include in response to the lifting offset applied to the lifting transform values being enabled, for a level-of-detail, decoding, by the processor, a bitstream based on the lifting offset numerator value and the lifting offset denominator value.

According to a further aspect of the present disclosure, a decoder is provided. The decoder may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, decode a third syntax element to determine a lifting offset numerator value. The memory storing instructions, which when executed by the processor, may cause the processor to, in response to the lifting offset applied to the lifting transform values being enabled, for a level-of-detail, decode a fourth syntax element to determine a lifting offset denominator value. The memory storing instructions, which when executed by the processor, may cause the processor to, in response to the lifting offset applied to the lifting transform values being enabled, for a level-of-detail, decode a bitstream based on the lifting offset numerator value and the lifting offset denominator value.

According to a further aspect of the present disclosure, an apparatus for decoding is provided. The apparatus for decoding may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, decode a third syntax element to determine a lifting offset numerator value. The memory storing instructions, which when executed by the processor, may cause the processor to, in response to the lifting offset applied to the lifting transform values being enabled, for a level-of-detail, decode a fourth syntax element to determine a lifting offset denominator value. The memory storing instructions, which when executed by the processor, may cause the processor to, in response to the lifting offset applied to the lifting transform values being enabled, for a level-of-detail, decode a bitstream based on the lifting offset numerator value and the lifting offset denominator value.

According to a further aspect of the present disclosure, a non-transitory computer-readable medium storing instructions for a decoder is provided is provided. The instructions, which when executed by the processor of the decoder, may cause the processor of the decoder to decode a first syntax element to determine which type of lifting transform is enabled. The instructions, which when executed by the processor of the decoder, may cause the processor of the decoder to, in response to a linear lifting transform being enabled, decode a second syntax element to determine whether a lifting offset applied to lifting transform values is enabled. The instructions, which when executed by the processor of the decoder, may cause the processor of the decoder to, in response to the lifting offset applied to the lifting transform values being enabled, for a level-of-detail, decode a third syntax element to determine a lifting offset numerator value. The instructions, which when executed by the processor of the decoder, may cause the processor of the decoder to, in response to the lifting offset applied to the lifting transform values being enabled, for a level-of-detail, decode a fourth syntax element to determine a lifting offset denominator value. The instructions, which when executed by the processor of the decoder, may cause the processor of the decoder to, in response to the lifting offset applied to the lifting transform values being enabled, for a level-of-detail, decode a bitstream based on the lifting offset numerator value and the lifting offset denominator value.

According to another aspect of the present disclosure, a method of encoding by an encoder is provided. The method may include encoding, by a processor, a first syntax element to determine which type of lifting transform is enabled. The method may include, in response to a linear lifting transform being enabled, encoding, by the processor, a second syntax element to determine whether a lifting offset applied to lifting transform values is enabled. The method may include in response to the lifting offset applied to the lifting transform values being enabled, for a level-of-detail, encoding, by the processor, a third syntax element to determine a lifting offset numerator value. The method may include in response to the lifting offset applied to the lifting transform values being enabled, for a level-of-detail, encoding, by the processor, a fourth syntax element to determine a lifting offset denominator value. The method may include in response to the lifting offset applied to the lifting transform values being enabled, for a level-of-detail, encoding, by the processor, a bitstream based on the lifting offset numerator value and the lifting offset denominator value.

According to a further aspect of the present disclosure, an encoder is provided. The encoder may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, encode a third syntax element to determine a lifting offset numerator value. The memory storing instructions, which when executed by the processor, may cause the processor to, in response to the lifting offset applied to the lifting transform values being enabled, for a level-of-detail, encode a fourth syntax element to determine a lifting offset denominator value. The memory storing instructions, which when executed by the processor, may cause the processor to, in response to the lifting offset applied to the lifting transform values being enabled, for a level-of-detail, encode a bitstream based on the lifting offset numerator value and the lifting offset denominator value.

According to a further aspect of the present disclosure, an apparatus for encoding is provided. The apparatus for encoding may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, encode a third syntax element to determine a lifting offset numerator value. The memory storing instructions, which when executed by the processor, may cause the processor to, in response to the lifting offset applied to the lifting transform values being enabled, for a level-of-detail, encode a fourth syntax element to determine a lifting offset denominator value. The memory storing instructions, which when executed by the processor, may cause the processor to, in response to the lifting offset applied to the lifting transform values being enabled, for a level-of-detail, encode a bitstream based on the lifting offset numerator value and the lifting offset denominator value.

According to a further aspect of the present disclosure, a non-transitory computer-readable medium storing instructions for an encoder is provided is provided. The instructions, which when executed by the processor of the encoder, may cause the processor of the encoder to encode a first syntax element to determine which type of lifting transform is enabled. The instructions, which when executed by the processor of the encoder, may cause the processor of the encoder to, in response to a linear lifting transform being enabled, encode a second syntax element to determine whether a lifting offset applied to lifting transform values is enabled. The instructions, which when executed by the processor of the encoder, may cause the processor of the encoder to, in response to the lifting offset applied to the lifting transform values being enabled, for a level-of-detail, encode a third syntax element to determine a lifting offset numerator value. The instructions, which when executed by the processor of the encoder, may cause the processor of the encoder to, in response to the lifting offset applied to the lifting transform values being enabled, for a level-of-detail, encode a fourth syntax element to determine a lifting offset denominator value. The instructions, which when executed by the processor of the encoder, may cause the processor of the encoder to, in response to the lifting offset applied to the lifting transform values being enabled, for a level-of-detail, encode a bitstream based on the lifting offset numerator value and the lifting offset denominator value.

According to yet another aspect of the present disclosure, a method of transmitting a bitstream is provided. The bitstream may be decoded or generated using one or more operations described herein.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates a diagram of a mesh data structure, according to some embodiments of the present disclosure.

FIG. 6 illustrates a diagram of a mesh with four vertices and three triangular faces, according to some embodiments of the present disclosure.

FIG. 7 illustrates a connectivity diagram of a mesh with four vertices and three triangular faces, according to some embodiments of the present disclosure.

FIG. 8 illustrates a data structure diagram for a parametrized mesh, according to some embodiments of the present disclosure.

FIG. 9 illustrates a diagram of a mesh with four vertices, three triangular faces, and a corresponding attribute map, according to some embodiments of the present disclosure.

FIG. 10 illustrates a diagram of mesh-face orientation based on vertex-index order, according to some embodiments of the present disclosure.

FIG. 11 illustrates a block diagram of a geometry-coding process implemented by an encoder, according to some embodiments of the present disclosure.

FIGS. 12A-12C illustrates a mesh subdivision and mesh displacement approximation process implemented by an encoder, according to some embodiments of the present disclosure.

FIG. 13 illustrates a diagram of displacement-component decomposition in a local-coordinate system, according to some embodiments of the present disclosure.

FIG. 14 illustrates a flow chart of a first exemplary method of decoding, according to some embodiments of the present disclosure.

FIG. 15 illustrates a flow chart of a second exemplary method of decoding, according to some embodiments of the present disclosure.

FIG. 16 illustrates a flow chart of a third exemplary method of decoding, according to some embodiments of the present disclosure.

FIG. 17 illustrates a flow chart of a first exemplary method of encoding, according to some embodiments of the present disclosure.

FIG. 18 illustrates a flow chart of a second exemplary method of encoding, according to some embodiments of the present disclosure.

FIG. 19 illustrates a flow chart of a third exemplary method of encoding, according to some embodiments of the present disclosure.

FIG. 20 illustrates a flow chart of a fourth exemplary method of decoding, according to some embodiments of the present disclosure.

FIG. 21 illustrates a flow chart of a fourth exemplary method of encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of dynamic mesh coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system. The techniques described herein may be used for various dynamic mesh coding applications. As described herein, dynamic mesh coding includes both encoding and decoding a dynamic mesh.

V-DMC has been widely used in virtual reality/augmented reality (VR/AR), telecommunication, autonomous vehicle, etc., for entertainment and industrial applications e.g., asset management for gaming, spatial media, architecture design modeling, and structural analysis. Moving Picture Experts Group (MPEG) released the first version of community draft for international standard for V-DMC and the Alliance for Open Media (AOM) is also developing mesh coding standard.

The existing V-DMC standards, however, cannot work well for a wide range of dynamic mesh inputs for many different applications. For example, besides the representation of levels (or coefficients in some cases), the representation of other information (e.g., parameters) used for V-DMC may be coded in the forms of syntax elements in the bitstream as well. Since V-DMC is organized in different levels by dividing a collection of points into different pieces (e.g., sequence, slices, etc.) associated with different properties (e.g., geometry, attributes, etc.), the parameter sets are also arranged in different levels (e.g., sequence-level, property-level, slice-level, etc.), for example, in the different headers. Moreover, multiple condition checks may be required for parsing some syntax elements in V-DMC, which further increases the complexity of organizing and parsing the representation of syntax elements.

To improve the flexibility and generality of dynamic mesh coding, the present disclosure provides various novel schemes of syntax element representation and organization, which are compatible with any suitable V-DMC standards, including, but not limited to, Alliance of Open Media (AOM) Volumetric Visual Media (VVM) standards and MPEG V-DMC standards.

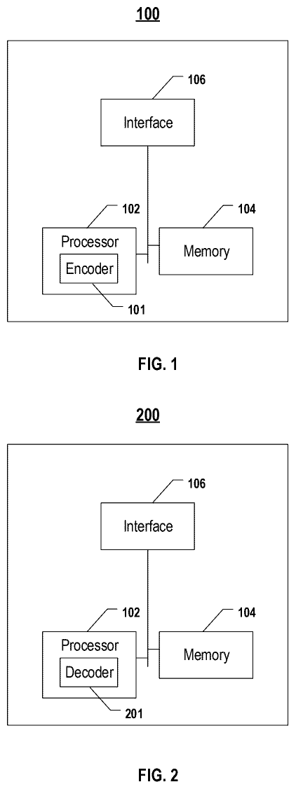

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatuses capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected one to another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing dynamic mesh coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running dynamic mesh encoding and decoding applications. In another example, processor 102, memory 104, and interface 106 may be integrated on a specialized processor chip for dynamic mesh coding, such as a GPU or ISP chip dedicated to graphic processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to dynamic mesh encoding, such as voxelization, transformation, quantization, arithmetic encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to dynamic mesh decoding, such as arithmetic decoding, dequantization, inverse transformation, reconstruction, synthesis, as described below in detail.

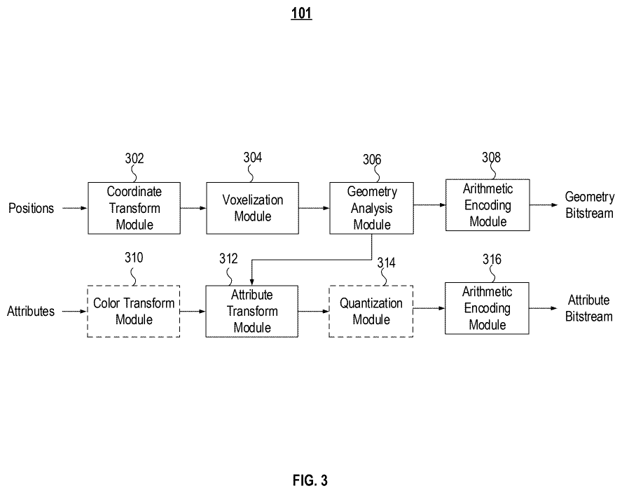

FIG. 3 illustrates a detailed block diagram of exemplary encoder 101 in encoding system 100 in FIG. 1, according to some embodiments of the present disclosure. As shown in FIG. 3, encoder 101 may include a coordinate transform module 302, a voxelization module 304, a geometry analysis module 306, and an arithmetic encoding module 308, together configured to encode positions associated with points of a dynamic mesh into a geometry bitstream (i.e., geometry encoding). As shown in FIG. 3, encoder 101 may also include a color transform module 310, an attribute transform module 312, a quantization module 314, and an arithmetic encoding module 316, together configured to encode attributes associated with vertices, or faces of a dynamic mesh into an attribute bitstream (i.e., attribute encoding). It is understood that each of the elements shown in FIG. 3 is independently shown to represent characteristic functions different from each other in a dynamic mesh encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101. It is still further understood that the modules shown in FIG. 3 are for illustrative purposes only, and in some examples, different modules may be included in encoder 101 for dynamic mesh encoding.

As shown in FIG. 3, geometry positions and attributes associated with vertices and faces of a mesh may be encoded separately. A geometry of a mesh may be a collection of vertices with positions Xₖ=(xₖ, yₖ, zₖ), k=1, . . . , K, where K is the number of vertices in the mesh, and attributes Aₖ=(A₁ₖ, A₂ₖ, . . . , A_{Dk}), k=1, . . . , K, where D is the number of attributes for each vertex. In some embodiments, attribute coding depends on decoded geometry. As a consequence, mesh vertex positions may be coded first. Since geometry positions may be represented by floating-point numbers in an original coordinate system, coordinate transform module 302 and a voxelization module 304 may be configured to perform a coordinate transformation followed by voxelization that quantizes and removes duplicate vertices. The process of position quantization, duplicate vertex removal, and assignment of attributes to the remaining vertices is called voxelization. The voxelized mesh may be represented using, for example, a list structure in a lossless manner. Geometry analysis module 306 may be configured to perform geometry analysis using, for example, the predictive vertex position coding scheme. Arithmetic encoding module 308 may be configured to arithmetically encode the resulting structure from geometry analysis module 306 into the geometry bitstream.

In some embodiments, geometry analysis module 306 is configured to perform geometry analysis using the predictive vertex position coding scheme. Under the predictive vertex position coding scheme, a. The geometry information (x, y, z) for one position may be represented by this defined predictive vertex position coding structure. Since mesh vertices may be duplicated, multiple mesh vertices may be mapped to the same sub-cube of size 1 (i.e., the same voxel). In order to handle such a situation, the corresponding attributes of voxels are averaged for each sub-cube of dimension 1.

Referring back to FIG. 3, as to attribute encoding, optionally, color transform module 310 may be configured to convert red/green/blue (RGB) color attributes of each point to YCbCr color attributes if the attributes include color. Attribute transform module 312 may be configured to perform attribute transformation based on the results from geometry analysis module 306 (e.g., using the predictive vertex position scheme), including but not limited to, the hybrid video coding. Optionally, quantization module 314 may be configured to quantize the transformed coefficients of attributes from attribute transform module 312 to generate quantization levels of the attributes associated with each point to reduce the dynamic range. Arithmetic encoding module 316 may be configured to arithmetically encode the resulting transformed coefficients of attributes associated with each mesh vertex or the quantization levels thereof into the attribute bitstream.

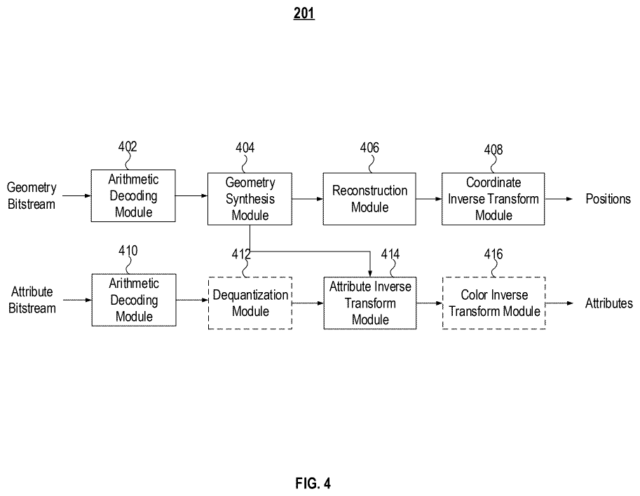

FIG. 4 illustrates a detailed block diagram of exemplary decoder 201 in decoding system 200 in FIG. 2, according to some embodiments of the present disclosure. As shown in FIG. 4, decoder 201 may include an arithmetic decoding module 402, a geometry synthesis module 404, a reconstruction module 406, and a coordinate inverse transform module 408, together configured to decode positions associated with vertices of a dynamic mesh from the geometry bitstream (i.e., geometry decoding). As shown in FIG. 4, decoder 201 may also include an arithmetic decoding module 410, a dequantization module 412, an attribute inverse transform module 414, and a color inverse transform module 416, together configured to decode attributes associated with vertices, or faces of a dynamic mesh from the attribute bitstream (i.e., attribute decoding). It is understood that each of the elements shown in FIG. 4 is independently shown to represent characteristic functions different from each other in a dynamic mesh decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201. It is still further understood that the modules shown in FIG. 4 are for illustrative purposes only, and in some examples, different modules may be included in decoder 201 for dynamic mesh decoding.

When a coded dynamic mesh bitstream (e.g., a geometry bitstream or an attribute bitstream) is input from a dynamic mesh encoder (e.g., encoder 101), the input bitstream may be decoded by decoder 201 in a procedure opposite to that of the dynamic mesh encoder. Thus, the details of decoding that are described above with respect to encoding may be skipped for case of description. Arithmetic decoding modules 402 and 410 may be configured to decode the geometry bitstream and attribute bitstream, respectively, to obtain various information encoded into the bitstream. For example, arithmetic decoding module 410 may decode the attribute bitstream to obtain the attribute information associated with each vertex, or face, such as the quantization levels or the coefficients of the attributes associated with each vertex, or face. Optionally, dequantization module 412 may be configured to dequantize the quantization levels of attributes associated with each vertex, or face to obtain the coefficients of attributes associated with each vertex, or face. Besides the attribute information, arithmetic decoding module 410 may parse the bitstream to obtain various other information (e.g., in the form of syntax elements), such as the syntax element indicative of the attribute coding order followed by the vertex list, connectivity information, mapping information dynamic mesh coding.

Inverse attribute transform module 414 may be configured to perform inverse attribute transformation, such as inverse mapping from 2d texture image to 3d mesh model, to transform the data from the projection domain (e.g., texture image) back to the attribute domain (e.g., luma and/or chroma information for color attributes). Optionally, color inverse transform module 416 may be configured to convert YCbCr color attributes to RGB color attributes.

As to the geometry decoding, geometry synthesis module 404, reconstruction module 406, and coordinate inverse transform module 408 of decoder 201 may be configured to perform the inverse operations of geometry analysis module 306, voxelization module 304, and coordinate transform module 302 of encoder 101, respectively.

Consistent with the scope of the present disclosure, encoder 101 and decoder 201 may be configured to adopt various novel schemes of syntax element representation and organization, as disclosed herein, to improve the flexibility and generality of dynamic mesh coding.

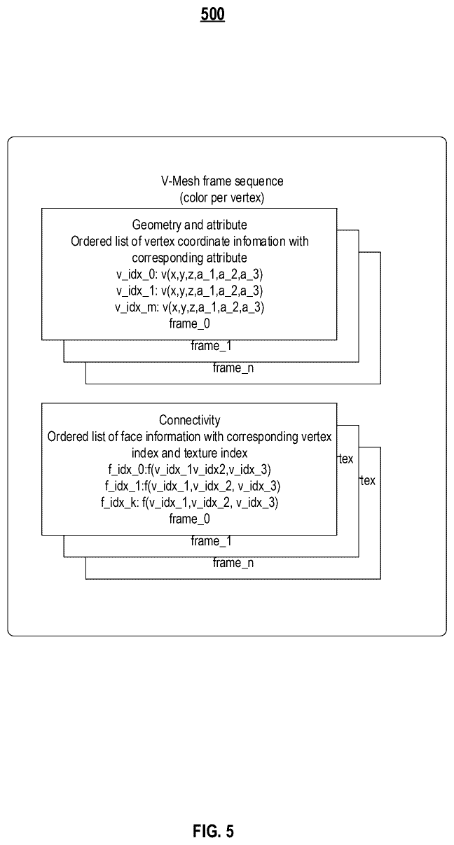

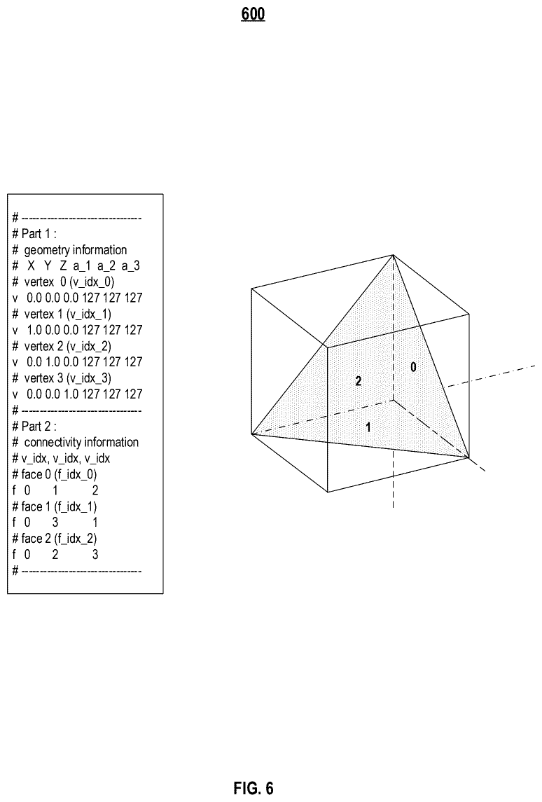

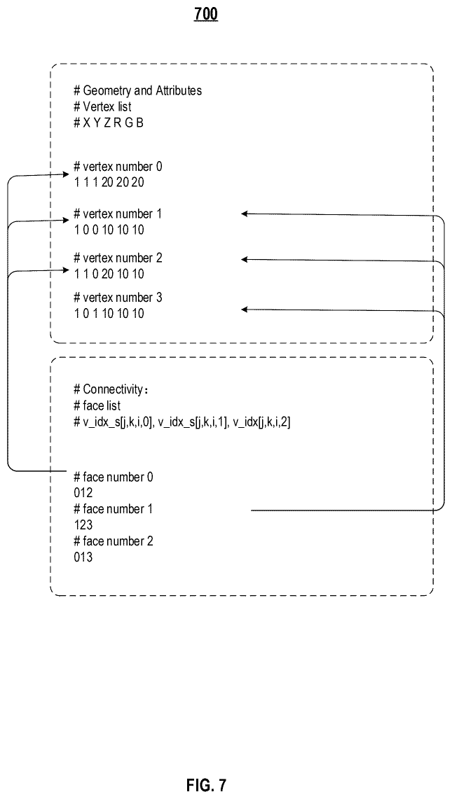

An example of geometry information for one mesh frame is depicted in the mesh data structure 500 illustrated in FIG. 5. FIG. 6 illustrates a diagram 600 of a mesh with four vertices and three triangular faces, according to some embodiments of the present disclosure. FIG. 7 illustrates a connectivity diagram 700 of a mesh with four vertices and three triangular faces, according to some embodiments of the present disclosure.

Referring to FIG. 6, an example of a surface, represented by a mesh with color-per-vertex characteristics, four vertices, and three faces. A position in space describes each vertex by X, Y, Z coordinates and color attributes red (R), green (G), and blue (B). As shown in FIG. 6, each face is defined by three vertex indices that form a triangle. A connectivity diagram of these features is illustrated in FIG. 7.

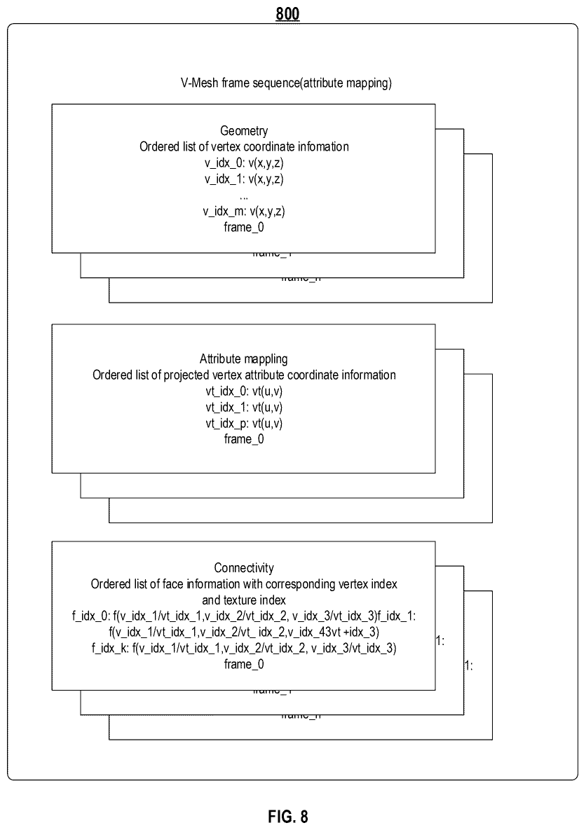

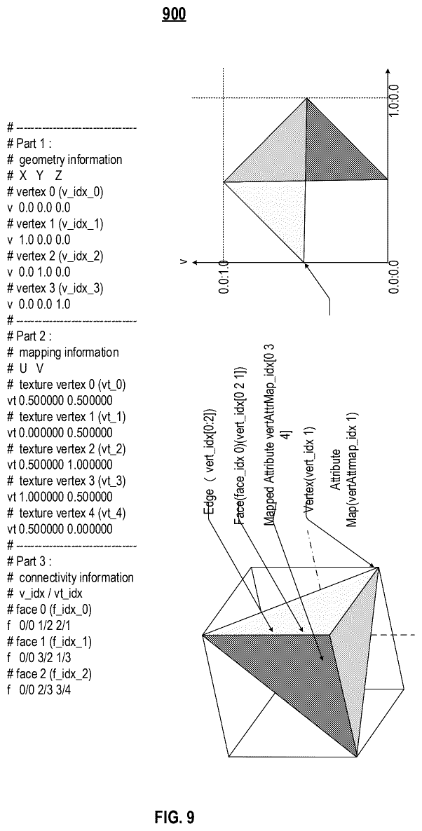

FIG. 8 illustrates a data structure diagram 800 for a parametrized mesh, according to some embodiments of the present disclosure. FIG. 9 illustrates a diagram 900 of a mesh with four vertices and three triangular faces and a corresponding attribute map, according to some embodiments of the present disclosure.

An example of a surface, represented by a mesh with attribute mapping characteristics (e.g., FIG. 8) that includes four vertices and three faces is depicted in FIG. 9. A position in space describes each vertex by X, Y, and Z coordinates. (U, V) denote attribute coordinates in the 2D texture vertex map. Each face is defined by three pairs of vertex indices, texture vertex coordinates that form a triangle in 3D space, and a triangle in the 2D texture map.

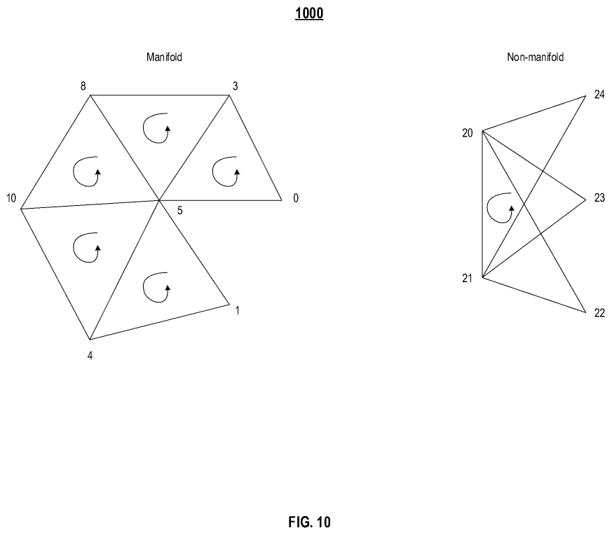

FIG. 10 illustrates a diagram of mesh-face orientation 1000 based on vertex-index order, according to some embodiments of the present disclosure. Referring to FIG. 10, the orientation of the face is determined using the right-hand coordinate system. The face includes three vertices that belong to three edges, and the three vertex indices describe each face. A manifold mesh is a mesh where one edge belongs to two different faces at most, as shown on the left-hand side of FIG. 10. On the other hand, a non-manifold mesh is a mesh with an edge that belongs to more than two faces, as shown on the right-hand side of FIG. 10.

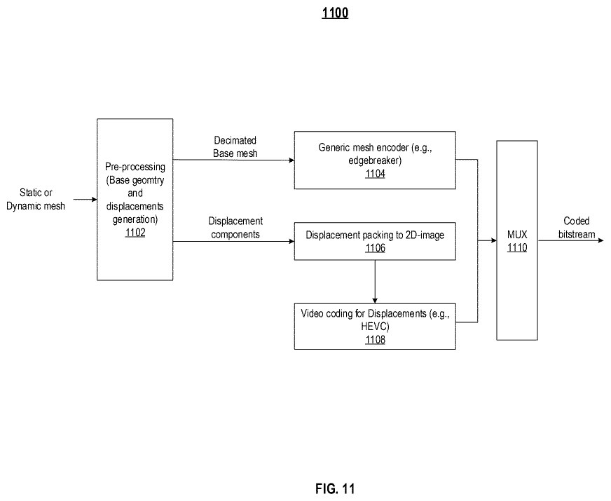

Some existing techniques apply a two-stage coding procedure to code geometry information. First, the geometry is decimated to create a base mesh encoded using generic geometry-coding method, e.g., “edgebreaker.” Then, the base mesh is hierarchically subdivided, and the difference between the subdivided point and the approximation of the original mesh is stored as the geometry displacements component. The displacement components are packed into a two-dimensional (2D) image and encoded with lossless video coding. A high-level diagram of the two-stage geometry-coding process 1100 is described below in connection with FIG. 11.

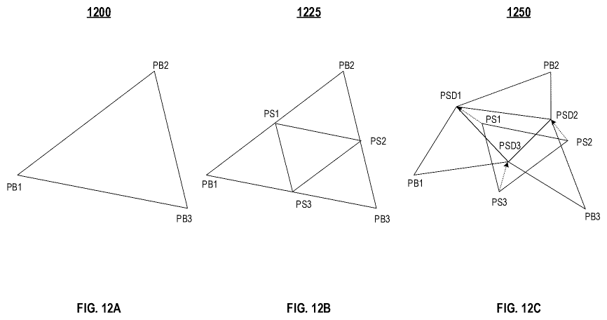

Referring to FIG. 11, an encoder may receive a static or dynamic mesh of a video, picture, frame, scene, etc. At 1102, the encoder may perform pre-processing to generate a base-mesh geometry and mesh displacements. The base-mesh geometry may include a decimated base mesh with a fewer number of points than the static or dynamic mesh that was originally received. The decimated base mesh may be input to a mesh encoder 1104 that implements, e.g., an edgebreaker encoding process. The mesh encoder may perform geometry encoding of the decimated base mesh. On the other hand, the mesh displacements may be input to a displacements-packing component 1106. The displacements-packing component 1106 may perform displacement coefficient packing to a 2D image, as described below in connection with FIGS. 12A-12C. The displacement packing information may be input to a video coder 1108 for displacements, e.g., such as an HEVC component. Mesh encoder 1104 and video coder 1108 may input their respective information to a multiplexer (MUX) 1110, which encodes the information into a bitstream.

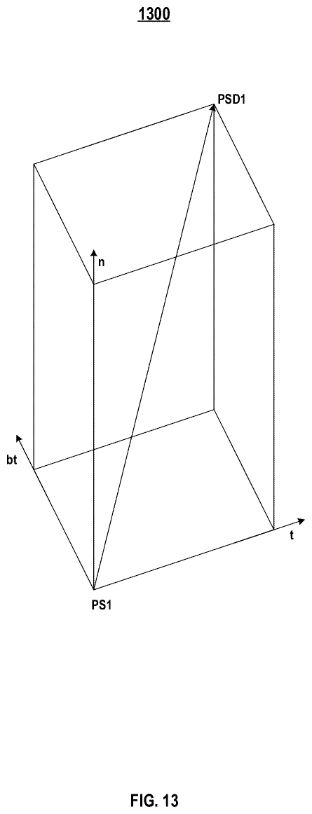

FIGS. 12A-12C illustrates a mesh subdivision and mesh displacement approximation process 1200, 1225, 1250 implemented by a displacements-packing component of an encoder, according to some embodiments of the present disclosure. FIG. 13 illustrates a diagram of displacement-component decomposition 1300 in a local-coordinate system, according to some embodiments of the present disclosure. This process is illustrated in FIGS. 12A-12C for one face in a base mesh.

Referring to FIG. 12A, PB1, PB2, and PB3 denote the base mesh points. PS1, PS2, and PS3, in FIG. 12B, represent subdivided points. PSD1, PSD2, and PSD3 represent subdivided displaced points, as shown in FIG. 12C. Subdivided point PS1 may be calculated as a mid-point between the PB1 and PB2 points. Then, the process can be recursively repeated. Referring to FIGS. 12C and 13, each vector of PS1 and PSD1 is described as three components in normal, tangent, and bitangent directions that are further mapped to color planes (e.g., Y, U, and V components in YUV 444 color space).

Existing v-DMC techniques signal the lifting parameter update in the mesh patch parameter syntax structure prior to signaling whether linear lifting is enabled as the transform method. Signaling the lifting parameter update flag increases signaling overhead unnecessarily when linear lifting is not enabled since lifting offset will not be needed for decoding.

To overcome these and other challenges, the present disclosure provides a technique in which the lifting parameter update (lifting parameter offset) is only signaled when the linear lifting transform is enabled, as shown below in Tables 1, 2, 3, and 4.

The exemplary signaling of the lifting parameter offset in the atlas sequence parameter set is shown below in Table 1.

TABLE 1
Atlas sequence parameter set V-DMC extension syntax

| | Descriptor |
|---|---|
| asps_vdmc_extension( ) { | |
| asve_subdivision_method | u(3) |
| if( asve_subdivision_method != 0 ) { | |
| asve_subdivision_iteration_count | u(3) |
| AspsSubdivisionCount = asve_subdivision_iteration_count | |
| } else | |
| AspsSubdivisionCount = 0 | |
| asve_1d_displacement_flag | u(1) |
| vdmc_quantization_parameters( 0, AspsSubdivisionCount ) | |
| asve_transform_method | u(3) |
| if(asve_transform_method == LINEAR_LIFTING) { | |
| vdmc_lifting_transform_parameters( 0, AspsSubdivisionCount ) | |
| asve_lifting_offset_flag | u(1) |
| } | |
| asve_num_attribute_video | u(7) |
| for(i=0; i< asve_num_attribute_video; i++){ | |
| asve_attribute_type_id[ i ] | u(8) |
| asve_attribute_frame_width[ i ] | ue(v) |
| asve_attribute_frame_height[ i ] | ue(v) |
| asve_attribute_subtexture_enabled_flag[ i ] | u(1) |
| } | |
| asve_packing_method | u(1) |
| asve_projection_textcoord_enable_flag | u(1) |
| if( asve_projection_textcoord_enable_flag ){ | |
| asve_projection_textcoord_mapping_method | u(2) |
| asve_projection_textcoord_scale_factor | fl(64) |
| } | |
| asve_displacement_reference_qp | u(7) |
| asve_vdmc_vui_parameters_present_flag | u(1) |
| if( asve_vdmc_vui_parameters_present_flag ) | |
| vdmc_vui_parameters( ) | |
| } | |

Referring to Table 1, an asve_lifting_offset_flag equal to 1 indicates that the lifting offset will be applied and sent per level-of-detail derived at the encoder. On the other hand, an asve_lifting_offset_flag equal to 0 indicates that lifting offset is disabled and will not be applied to the lifting transformed values.

The exemplary signaling of lifting parameter offset in the mesh patch data unit are shown below in Table 2.

TABLE 2
Mesh data unit syntax

| | Descriptor |
|---|---|
| meshpatch_data_unit( tileID, patchIdx ) { | |
| mdu_submesh_id[ tileID ][ patchIdx ] | u(v) |
| mdu_vertex_count_minus1[ tileID ][ patchIdx ] | ue(v) |
| mdu_face_count_minus1[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| mdu_parameters_override_flag[ tileID ][ patchIdx ] | u(1) |
| if( mdu_parameters_override_flag[ tileID ][ patchIdx ] ){ | |
| mdu_subdivision_override_flag[ tileID ][ patchIdx ] | u(1) |
| mdu_quantization_override_flag[ tileID ][ patchIdx ] | u(1) |
| mdu_transform_method_override_flag[ tileID ][ patchIdx ] | u(1) |
| mdu_transform_parameters_override_flag[ tileID ][ patchIdx ] | u(1) |
| } | |
| if( mdu_subdivision_override_flag[ tileID ][ patchIdx ] ){ | |
| mdu_subdivision_method[ tileID ][ patchIdx ] | u(3) |
| if( mdu_subdivision_method[ tileID ][ patchIdx ] != 0 ){ | |
| mdu_subdivision_iteration_count[ tileID ][ patchIdx ] | u(3) |
| PatchSubdivisionCount[ tileID ][ patchIdx ] = | |
| mdu_subdivision_iteration_count[ tileID ][ patchIdx ] | |
| } else { | |
| PatchSubdivisionCount[ tileID ][ patchIdx ] = 0 | |
| } | |
| } else { | |
| PatchSubdivisionCount[ tileID ][ patchIdx ] = AfpsSubdivisonCount | |
| } | |
| if(asve_lifting_offset_flag){ | |
| for( i=0 ; i < AfpsSubdivisonCount; i++ ) { | |
| mdu_lifting_offset_num[ tileID ][ patchIdx ][i] | se(v) |
| mdu_lifting_offset_denum_minus1[ tileID ][ patchIdx ][i] | ue(v) |
| } | |
| if(mdu_quantization_override_flag[ tileID ][ patchIdx ]) | |
| vdmc_quantization_parameters(2, PatchSubdivisionCount[ tileID ][ patchId | |
| x ]) | |
| mdu_displacement_coordinate_system[ tileID ][ patchIdx ] | u(1) |
| if(mdu_transform_method_override_flag[ tileID ][ patchIdx ]) | |
| mdu_transform_method[ tileID ][ patchIdx ] | u(3) |
| if(mdu_transform_method[ tileID ][ patchIdx ] == LINEAR_LIFTING && | |
| mdu_transform_parameters_override_flag[ tileID ][ patchIdx ]) { | |
| vdmc_lifting_transform_parameters(2, PatchSubdivisionCount[ tileID ][ pat | |
| chIdx ] ) | |
| } | |
| for( i=0; i< asve_num_attribute_video; i++ ){ | |
| if( asve_attribute_subtexture_enabled_flag[ i ] ){ | |
| mdu_attributes_2d_pos_x[ tileID ][ patchIdx ][ i ] | ue(v) |
| mdu_attributes_2d_pos_y[ tileID ][ patchIdx ][ i ] | ue(v) |
| mdu_attributes_2d_size_x_minus1[ tileID ][ patchIdx ][ i ] | ue(v) |
| mdu_attributes_2d_size_y_minus1[ tileID ][ patchIdx ][ i ] | ue(v) |
| } | |
| } | |
| if( afve_projection_texcoord_present_flag[ smIdx ] ) | |
| texture_projection_information( tileID, patchIdx ) | |
| } | |

Referring to Table 2, mdu_lifting_offset_num[tilelD][patchIdx][i] indicates the numerator of the lifting offset used to address the bias in the lifting transform of the i^{th} level of detail, and mdu_lifting_offset_denum_minus1[tileID][patchIdx][i] plus 1 indicates the denominator of the lifting offset used to address the bias in the lifting transform of the i^{th} level of detail. The lifting offsets signaled in the mesh data unit syntax may be for decoding a base mesh from the bitstream.

The exemplary signaling of lifting parameter offset in the lifting transform parameters syntax are shown below in Tables 3 and 4.

TABLE 3
Lifting transform parameters syntax

| | Descriptor |
|---|---|
| vdmc_lifting_transform_parameters( ltpIndex, subdivisionCount ){ | |
| vltp_skip_update_flag[ ltpIndex ] | u(1) |
| if( asve_lifting_update_flag && ltpIndex == 2 ) { | |
| vltp_lifting_offset_update_flag[ ltpIndex ] | u(1) |
| if( vltp_lifting_offset_update_flag[ ltpIndex ] ) { | |
| for( i = 0; i < subdivisionCount + 1; i++ ) { | |
| vltp_offset_num[ ltpIndex ] | se(v) |
| vltp_offest_denum_minus_1[ ltpIndex ] | ue(v) |
| } | |
| } | |
| } | |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| vltp_adaptive_update_weight_flag[ i ] | u(1) |
| if( vltp_lod_lifting_parameter_flag[ ltpIndex ] == 1 \|\| i == 0) { | |
| if( vltp_adaptive_update_weight_flag[ i ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ItpIndex ] = 1 ÷ ( 1 << vltp_log2_lifting_prediction_wei | |
| ght[ ltpIndex ] ) | |
| } | |

Referring to Table 3, vltp_offset_num[ltpIndex] indicates the numerator of the lifting offset used to address the bias in the lifting transform of the i^{th} level of detail, and vltp_offest_denum_minus_1[ltpIndex] indicates the denominator of the lifting offset used to address the bias in the lifting transform of the i^{th} level of detail. The lifting offsets signaled in the lifting transform parameters syntax may be for decoding a base-mesh displacement from the bitstream.

In some implementations, the lifting transform parameters may be updated for each ltpIndex, e.g., such as 0 for sequence, 1 for frame, and 2 for patch, as shown below in Table 4.

TABLE 4
Lifting transform parameters syntax

| | Descriptor |
|---|---|
| vdmc_lifting_transform_parameters( ltpIndex, subdivisionCount ){ | |
| vltp_skip_update_flag[ ltpIndex ] | u(1) |
| if( asve_lifting_update_flag ) { | |
| vltp_lifting_offset_update_flag[ ltpIndex ] | u(1) |
| if( vltp_lifting_offset_update_flag[ ltpIndex ] ) { | |
| for( i = 0; i < subdivisionCount + 1; i++ ) { | |
| vltp_offset_num[ ltpIndex ] | se(v) |
| vltp_offest_denum_minus_1[ ltpIndex ] | ue(v) |
| } | |
| } | |
| } | |
| vltp_lod_lifting_parameter_flag[ ltpIndex ] | u(1) |
| for( i=0 ; i < subdivisionCount + 1; i++ ) { | |
| if( vltp_skip_update_flag[ ltpIndex ] ) | |
| UpdateWeight[ ltpIndex ][ i ] = 0 | |
| else { | |
| vltp_adaptive_update_weight_flag[ i ] | u(1) |
| if( vltp_lod_lifting_parameter_flag[ ltpIndex ] == 1 \|\| i == 0) { | |
| if( vltp_adaptive_update_weight_flag[ i ] ) { | |
| vltp_lifting_update_weight_numerator[ ltpIndex ][ i ] | ue(v) |
| vltp_lifting_update_weight_denominator_minus1[ ltpIndex ][ i ] | ue(v) |
| UpdateWeight[ ltpIndex ][ i ] = | |
| ( vltp_lifting_update_weight_numerator[ ltpIndex ][ i ] ) ÷ | |
| ( vltp_lifting_update_weight_denominator_minus1[ ltpIndex ][ i ] + 1 ) | |
| } else { | |
| vltp_log2_lifting_update_weight[ ltpIndex ][ i ] | ue(v) |
| UpdateWeight[ ltpIndex ][ i ] = | |
| 1 ÷ ( 1 << vltp_log2_lifting_update_weight[ ltpIndex ][ i ] ) | |
| } | |
| } else { | |
| UpdateWeight[ ltpIndex ][ i ] = UpdateWeight[ ltpIndex ][ 0 ] | |
| } | |
| } | |
| } | |
| vltp_log2_lifting_prediction_weight[ ltpIndex ] | ue(v) |
| PredictionWeight[ ltpIndex ] = 1 ÷ ( 1 << vltp_log2_lifting_prediction_w | |
| eight[ ltpIndex ] ) | |
| } | |

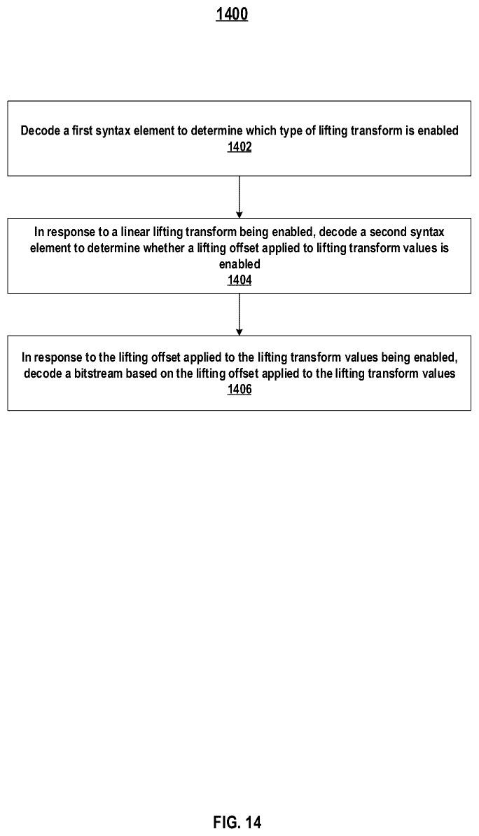

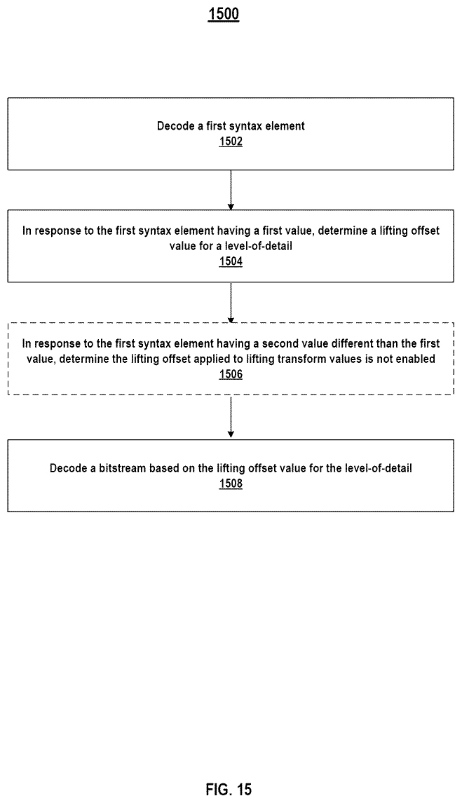

FIG. 14 illustrates a flow chart of a first exemplary method 1400 of decoding by a decoder, according to some embodiments of the present disclosure. Method 1400 may be performed by an apparatus, e.g., such as decoder 201 of decoding system 200 or any other suitable decoding system. Method 1400 may include operations 1402-1406 as described below. It is understood that some of the operations may be optional (indicated with dashed lines), and some of the operations may be performed simultaneously, or in a different order other than shown in FIG. 14.

At 1402, the apparatus may decode a first syntax element to determine which type of lifting transform is enabled. In some implementations, the first syntax element may indicate which type of lifting transform is enabled.

At 1404, the apparatus may, in response to the linear lifting transform being enabled, decode a second syntax element to determine whether a lifting offset applied to lifting transform values is enabled. In some implementations, the second syntax element indicates whether the lifting offset applied to the lifting transform values is enabled.

In some implementations, in response to the linear lifting transform being enabled, to decode the second syntax element to determine whether the lifting offset applied to lifting transform values is enabled, the apparatus may, in response to the second syntax element having a first value, determine the lifting offset applied to lifting transform values is enabled. In some implementations, the lifting offset applied to the lifting transform values may be sent per level-of-detail. In some implementations, in response to the linear lifting transform being enabled, to decode the second syntax element to determine whether the lifting offset applied to lifting transform values is enabled, the apparatus may, in response to the second syntax element having a second value different than the first value, determine the lifting offset applied to lifting transform values is not enabled.

At 1406, the apparatus may, in response to the lifting offset applied to the lifting transform values being enabled, decode a bitstream based on the lifting offset applied to the lifting transform values.

FIG. 15 illustrates a flow chart of a second exemplary method 1500 of decoding by a decoder, according to some embodiments of the present disclosure. Method 1500 may be performed by an apparatus, e.g., such as decoder 201 of decoding system 200 or any other suitable decoding system. Method 1500 may include operations 1502-1508 as described below. It is understood that some of the operations may be optional (indicated with dashed lines), and some of the operations may be performed simultaneously, or in a different order other than shown in FIG. 15.

At 1502, the apparatus may decode a first syntax element. In some implementations, the first syntax element may indicate which type of lifting transform is enabled.

At 1504, the apparatus may, in response to the first syntax element having a first value, determine a lifting offset value for each level-of-detail.

In some implementations, in response to the first syntax element having the first value, the determining, by the processor, the lifting offset value for each level-of-detail may include decoding, by the processor, a second syntax element to determine a lifting offset numerator value. In some implementations, the second syntax element may indicate the lifting offset numerator value. In some implementations, in response to the first syntax element having the first value, the determining, by the processor, the lifting offset value for each level-of-detail may include decoding, by the processor, a third syntax element to determine a lifting offset denominator value. In some implementations, the third syntax element may indicate the lifting offset denominator value.

At 1506, the apparatus may in response to the first syntax element having a second value different than the first value, determine the lifting offset applied to lifting transform values is not enabled.

At 1508, the apparatus may decode a bitstream based on the lifting offset value for each level of detail. In some implementations, the decoding, by the processor, the bitstream based on the lifting offset value for each level of detail may include decoding, by the processor, the bitstream based on the lifting offset numerator value and the lifting offset denominator value.

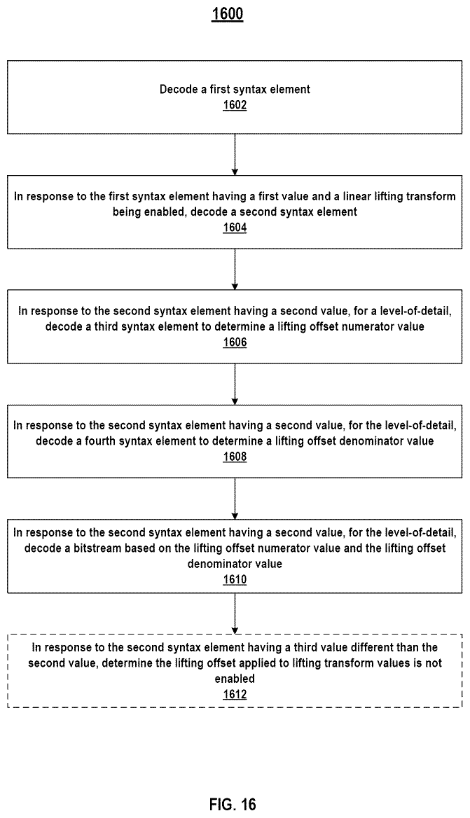

FIG. 16 illustrates a flow chart of a third exemplary method 1600 of decoding by a decoder, according to some embodiments of the present disclosure. Method 1600 may be performed by an apparatus, e.g., such as decoder 201 of decoding system 200 or any other suitable decoding system. Method 1600 may include operations 1602-1612 as described below. It is understood that some of the operations may be optional (indicated with dashed lines), and some of the operations may be performed simultaneously, or in a different order other than shown in FIG. 16.

At 1602, the apparatus may decode a first syntax element. In some implementations, the first syntax element may indicate which type of lifting transform is enabled.

At 1604, the apparatus, in response to the first syntax element having a first value and a linear lifting transform being enabled, decode a second syntax element. In some implementations, the second syntax element may indicate whether a lifting offset value is updated.

At 1606, the apparatus, in response to the second syntax element having a second value, for a level-of-detail, decode a third syntax element to determine a lifting offset numerator value. In some implementations, the third syntax element may indicate the lifting offset numerator value.

At 1608, the apparatus may, in response to the second syntax element having a second value, for the level-of-detail, decode a fourth syntax element to determine a lifting offset denominator value. In some implementations, the fourth syntax element may indicate the lifting offset denominator value.

At 1610, the apparatus may, in response to the second syntax element having a second value, for the level-of-detail, decode a bitstream based on the lifting offset numerator value and the lifting offset denominator value. In some implementations, in response to the second syntax element having a second value, for the level-of-detail, to decode a bitstream based on the lifting offset numerator value and the lifting offset denominator value, the apparatus may decode a base-mesh displacement from the bitstream based on the lifting offset numerator value and the lifting offset denominator value.

At 1612, the apparatus may, in response to the second syntax element having a third value different than the second value, determine the lifting offset applied to lifting transform values is not enabled.

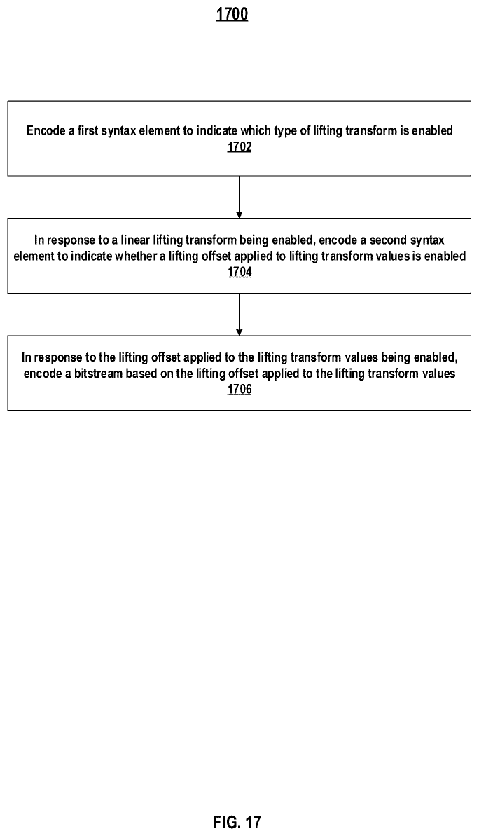

FIG. 17 illustrates a flow chart of a first exemplary method 1700 of encoding by an encoder, according to some embodiments of the present disclosure. Method 1700 may be performed by encoder 101 of encoding system 100 or any other suitable encoding system. Method 1700 may include operations 1702-1706 as described below. It is understood that some of the operations may be optional (indicated with dashed lines), and some of the operations may be performed simultaneously, or in a different order other than shown in FIG. 17.

At 1702, the apparatus may encode a first syntax element to determine which type of lifting transform is enabled. In some implementations, the first syntax element may indicate which type of lifting transform is enabled.

At 1704, the apparatus may, in response to the linear lifting transform being enabled, encode a second syntax element to determine whether a lifting offset applied to lifting transform values is enabled. In some implementations, the second syntax element indicates whether the lifting offset applied to the lifting transform values is enabled.

In some implementations, in response to the linear lifting transform being enabled, to encode the second syntax element to determine whether the lifting offset applied to lifting transform values is enabled, the apparatus may, in response to the second syntax element having a first value, determine the lifting offset applied to lifting transform values is enabled. In some implementations, the lifting offset applied to the lifting transform values may be sent per level-of-detail. In some implementations, in response to the linear lifting transform being enabled, to encode the second syntax element to determine whether the lifting offset applied to lifting transform values is enabled, the apparatus may, in response to the second syntax element having a second value different than the first value, determine the lifting offset applied to lifting transform values is not enabled.

At 1706, the apparatus may, in response to the lifting offset applied to the lifting transform values being enabled, encode a bitstream based on the lifting offset applied to the lifting transform values.

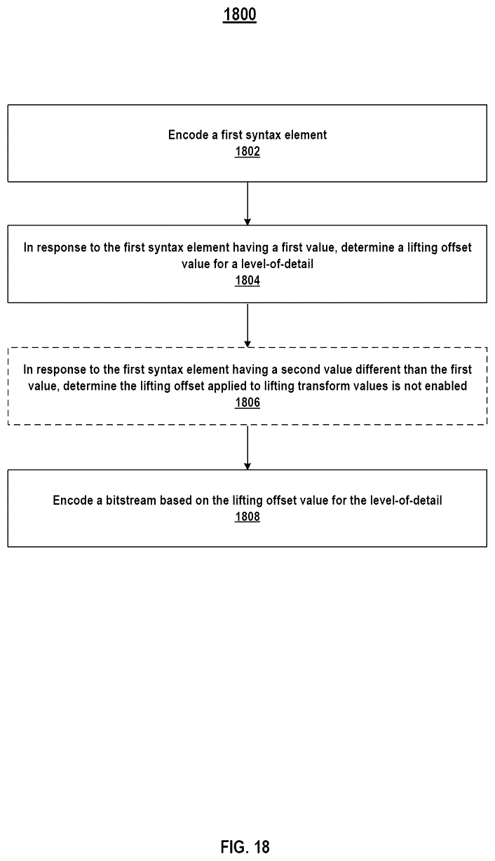

FIG. 18 illustrates a flow chart of a second exemplary method 1800 of encoding by an encoder, according to some embodiments of the present disclosure. Method 1800 may be performed by encoder 101 of encoding system 100 or any other suitable encoding system. Method 1800 may include operations 1802-1808 as described below. It is understood that some of the operations may be optional (indicated with dashed lines), and some of the operations may be performed simultaneously, or in a different order other than shown in FIG. 18.

At 1802, the apparatus may encode a first syntax element. n some implementations, the first syntax element may indicate which type of lifting transform is enabled.

At 1804, the apparatus may, in response to the first syntax element having a first value, determine a lifting offset value for each level-of-detail.

In some implementations, in response to the first syntax element having the first value, the determining, by the processor, the lifting offset value for each level-of-detail may include encoding, by the processor, a second syntax element to determine a lifting offset numerator value. In some implementations, the second syntax element may indicate the lifting offset numerator value. In some implementations, in response to the first syntax element having the first value, the determining, by the processor, the lifting offset value for each level-of-detail may include encoding, by the processor, a third syntax element to determine a lifting offset denominator value. In some implementations, the third syntax element may indicate the lifting offset denominator value.

At 1806, the apparatus may in response to the first syntax element having a second value different than the first value, determine the lifting offset applied to lifting transform values is not enabled.

At 1808, the apparatus may encode a bitstream based on the lifting offset value for each level of detail. In some implementations, the encoding, by the processor, the bitstream based on the lifting offset value for each level of detail may include encoding, by the processor, the bitstream based on the lifting offset numerator value and the lifting offset denominator value.

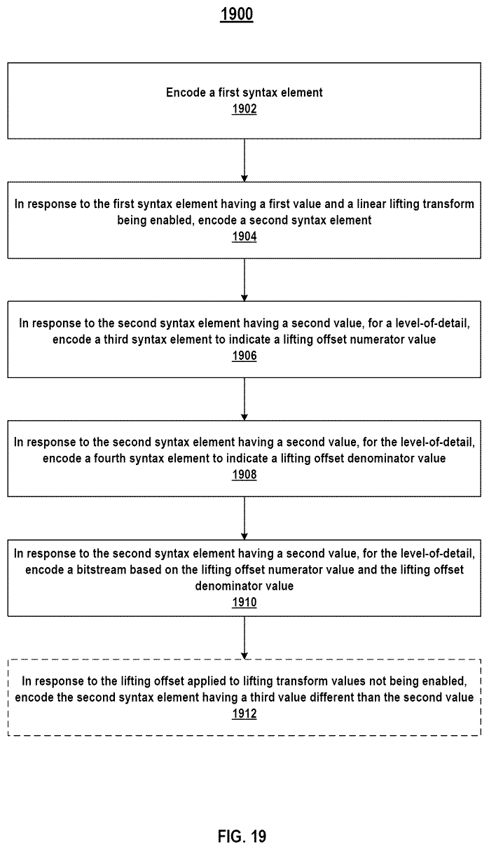

FIG. 19 illustrates a flow chart of a third exemplary method 1900 of encoding by an encoder, according to some embodiments of the present disclosure. Method 1900 may be performed by encoder 101 of encoding system 100 or any other suitable encoding system. Method 1900 may include operations 1902-1912 as described below. It is understood that some of the operations may be optional (indicated with dashed lines), and some of the operations may be performed simultaneously, or in a different order other than shown in FIG. 19.

At 1902, the apparatus may encode a first syntax element. In some implementations, the first syntax element may indicate which type of lifting transform is enabled.

At 1904, the apparatus, in response to the first syntax element having a first value and a linear lifting transform being enabled, encode a second syntax element. In some implementations, the second syntax element may indicate whether a lifting offset value is updated.

At 1906, the apparatus, in response to the second syntax element having a second value, for a level-of-detail, encode a third syntax element to determine a lifting offset numerator value. In some implementations, the third syntax element may indicate the lifting offset numerator value.

At 1908, the apparatus may, in response to the second syntax element having a second value, for the level-of-detail, encode a fourth syntax element to determine a lifting offset denominator value. In some implementations, the fourth syntax element may indicate the lifting offset denominator value.

At 1910, the apparatus may, in response to the second syntax element having a second value, for the level-of-detail, encode a bitstream based on the lifting offset numerator value and the lifting offset denominator value. In some implementations, in response to the second syntax element having a second value, for the level-of-detail, to encode a bitstream based on the lifting offset numerator value and the lifting offset denominator value, the apparatus may encode a base-mesh displacement from the bitstream based on the lifting offset numerator value and the lifting offset denominator value.

At 1912, the apparatus may, in response to the second syntax element having a third value different than the second value, determine the lifting offset applied to lifting transform values is not enabled.

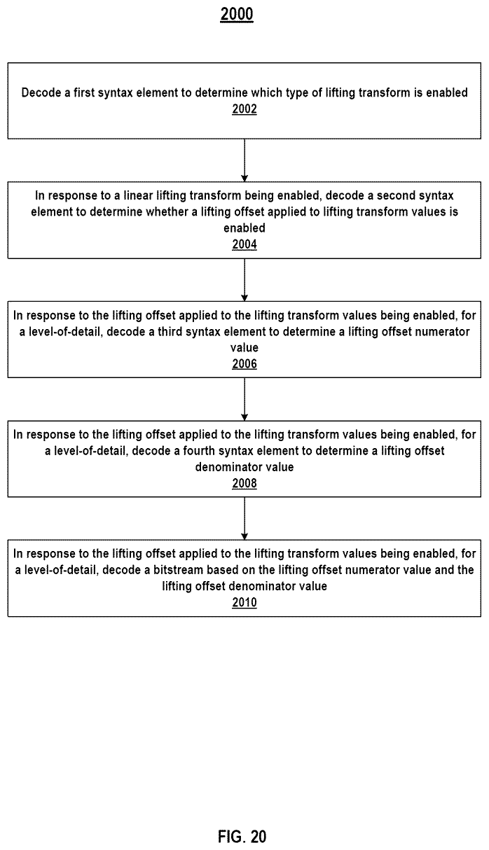

FIG. 20 illustrates a flow chart of a fourth exemplary method 2000 of decoding by a decoder, according to some embodiments of the present disclosure. Method 2000 may be performed by an apparatus, e.g., such as decoder 201 of decoding system 200 or any other suitable decoding system. Method 2000 may include operations 2002-2010 as described below. It is understood that some of the operations may be optional (indicated with dashed lines), and some of the operations may be performed simultaneously, or in a different order other than shown in FIG. 20.

At 2002, the apparatus may decode a first syntax element to determine which type of lifting transform is enabled. In some implementations, the first syntax element may indicate which type of lifting transform is enabled.

At 2004, the apparatus may, in response to a linear lifting transform being enabled, decode a second syntax element to determine whether a lifting offset applied to lifting transform values is enabled. In some implementations, the second syntax element may indicate whether a lifting offset applied to the lifting transform values is enabled. In some implementations, in response to the linear lifting transform being enabled, to decode the second syntax element to determine whether the lifting offset applied to lifting transform values is enabled, the apparatus may, in response to the second syntax element having a first value, determine the lifting offset applied to the lifting transform values is enabled. In some implementations, in response to the linear lifting transform being enabled, to decode the second syntax element to determine whether the lifting offset applied to lifting transform values is enabled, the apparatus may, in response to the second syntax element having a second value different than the first value, determine the lifting offset applied to lifting transform values is not enabled.

At 2006, the apparatus may, in response to the lifting offset applied to the lifting transform values being enabled, for a level-of-detail, decode a third syntax element to determine a lifting offset numerator value. In some implementations, the third syntax element may indicate the lifting offset numerator value.

At 2008, the apparatus may, in response to the lifting offset applied to the lifting transform values being enabled, for a level-of-detail, decode a fourth syntax element to determine a lifting offset denominator value. In some implementations, the fourth syntax element may indicate the lifting offset denominator value.

At 2010, the apparatus may, in response to the lifting offset applied to the lifting transform values being enabled, for a level-of-detail, decode a bitstream based on the lifting offset numerator value and the lifting offset denominator value. In some implementations, in response to the lifting offset applied to the lifting transform values being enabled, for the level-of-detail, to decode the bitstream based on the lifting offset numerator value and the lifting offset denominator value, the apparatus may decode a base-mesh displacement from the bitstream based on the lifting offset numerator value and the lifting offset denominator value.

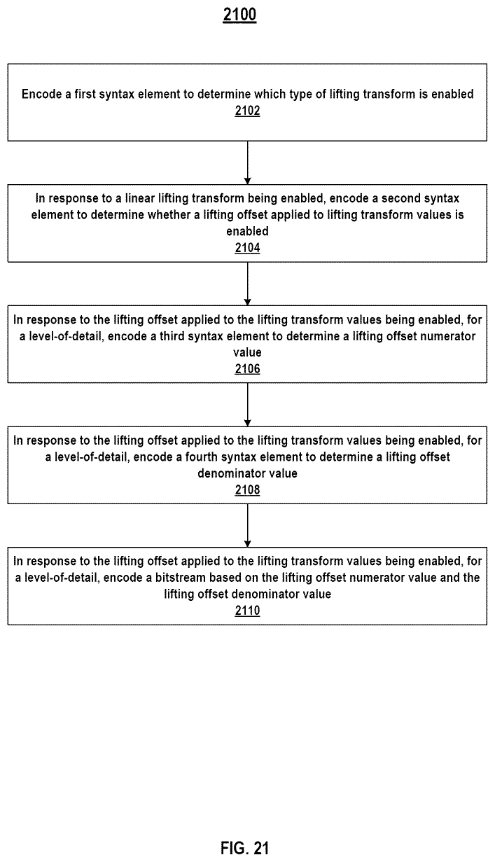

FIG. 21 illustrates a flow chart of a fourth exemplary method 2100 of encoding by an encoder, according to some embodiments of the present disclosure. Method 2100 may be performed by encoder 101 of encoding system 100 or any other suitable encoding system. Method 2100 may include operations 2102-2110 as described below. It is understood that some of the operations may be optional (indicated with dashed lines), and some of the operations may be performed simultaneously, or in a different order other than shown in FIG. 21.

At 2102, the apparatus may encode a first syntax element to determine which type of lifting transform is enabled. In some implementations, the first syntax element may indicate which type of lifting transform is enabled.

At 2104, the apparatus may, in response to a linear lifting transform being enabled, encode a second syntax element to determine whether a lifting offset applied to lifting transform values is enabled. In some implementations, the second syntax element may indicate whether a lifting offset applied to the lifting transform values is enabled. In some implementations, in response to the linear lifting transform being enabled, to encode the second syntax element to determine whether the lifting offset applied to lifting transform values is enabled, the apparatus may, in response to the second syntax element having a first value, determine the lifting offset applied to the lifting transform values is enabled. In some implementations, in response to the linear lifting transform being enabled, to encode the second syntax element to determine whether the lifting offset applied to lifting transform values is enabled, the apparatus may, in response to the second syntax element having a second value different than the first value, determine the lifting offset applied to lifting transform values is not enabled.

At 2106, the apparatus may, in response to the lifting offset applied to the lifting transform values being enabled, for a level-of-detail, encode a third syntax element to determine a lifting offset numerator value. In some implementations, the third syntax element may indicate the lifting offset numerator value.

At 2108, the apparatus may, in response to the lifting offset applied to the lifting transform values being enabled, for a level-of-detail, encode a fourth syntax element to determine a lifting offset denominator value. In some implementations, the fourth syntax element may indicate the lifting offset denominator value.

At 2110, the apparatus may, in response to the lifting offset applied to the lifting transform values being enabled, for a level-of-detail, encode a bitstream based on the lifting offset numerator value and the lifting offset denominator value. In some implementations, in response to the lifting offset applied to the lifting transform values being enabled, for the level-of-detail, to encode the bitstream based on the lifting offset numerator value and the lifting offset denominator value, the apparatus may encode a base-mesh displacement from the bitstream based on the lifting offset numerator value and the lifting offset denominator value.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk, where disks usually reproduce data magnetically, while discs reproduce data optically with lasers. Combinations of the above should also be included within the scope of computer-readable media.

According to one aspect of the present disclosure, a method of decoding by a decoder is provided. The method may include decoding, by a processor, a first syntax element to determine which type of lifting transform is enabled. The method may include, in response to a linear lifting transform being enabled, decoding, by the processor, a second syntax element to determine whether a lifting offset applied to lifting transform values is enabled. The method may include, in response to the lifting offset applied to the lifting transform values being enabled, decoding, by the processor, a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, the decoding, by the processor, the second syntax element to determine whether the lifting offset applied to lifting transform values is enabled may include, in response to the second syntax element having a first value, determining, by the processor, the lifting offset applied to lifting transform values is enabled and sent per level-of-detail.

In some implementations, in response to the linear lifting transform being enabled, the decoding, by the processor, the second syntax element to determine whether the lifting offset applied to lifting transform values is enabled may include, in response to the second syntax element having a second value different than the first value, determining, by the processor, the lifting offset applied to lifting transform values is not enabled.

According to another aspect of the present disclosure, a method of decoding by a decoder is provided. The method may include decoding, by a processor, a first syntax element. The method may include, in response to the first syntax element having a first value, determining, by the processor, a lifting offset value for each level-of-detail. The method may include decoding, by the processor, a bitstream based on the lifting offset value for each level of detail.

According to a further aspect of the present disclosure, a method of decoding by a decoder is provided. The method may include decoding, by a processor, a first syntax element. The method may, in response to the first syntax element having a first value and a linear lifting transform being enabled, decoding, by the processor, a second syntax element. The method may include, in response to the second syntax element having a second value, for a level-of-detail, decoding, by the processor, a third syntax element to determine a lifting offset numerator value. The method may include, in response to the second syntax element having a second value, for the level-of-detail, decoding, by the processor, a fourth syntax element to determine a lifting offset denominator value. The method may include, in response to the second syntax element having a second value, for the level-of-detail, decoding, by the processor, a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, the decoding, by the processor, the bitstream based on the lifting offset numerator value and the lifting offset denominator value may include decoding, by the processor, a base-mesh displacement from the bitstream based on the lifting offset numerator value and the lifting offset denominator value.

In some implementations, the first value and the second value may be a same value.

In some implementations, the method may include, in response to the second syntax element having a third value different than the second value, determining, by the processor, the lifting offset applied to lifting transform values is not enabled.

According to yet another aspect of the present disclosure, a decoder is provided. The decoder may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, decode a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, to decode the second syntax element to determine whether the lifting offset applied to lifting transform values is enabled, the memory storing instructions, which when executed by the processor, may cause the processor to, in response to the second syntax element having a first value, determine the lifting offset applied to lifting transform values is enabled. In some implementations, the lifting offset applied to the lifting transform values may be sent per level-of-detail.

In some implementations, in response to the linear lifting transform being enabled, to decode the second syntax element to determine whether the lifting offset applied to lifting transform values is enabled, the memory storing instructions, which when executed by the processor, may cause the processor to, in response to the second syntax element having a second value different than the first value, determine the lifting offset applied to lifting transform values is not enabled.

According to still a further aspect of the present disclosure, a decoder is provided. The decoder may include a processor and memory storing instructions. The memory storing instructions, which when executed by the processor, may cause the processor to decode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to decode a bitstream based on the lifting offset value for each level of detail.

In some implementations, in response to the first syntax element having the first value, to determine the lifting offset value for each level-of-detail, the memory storing instructions, which when executed by the processor, may cause the processor to decode a second syntax element to determine a lifting offset numerator value. In some implementations, in response to the first syntax element having the first value, to determine the lifting offset value for each level-of-detail, the memory storing instructions, which when executed by the processor, may cause the processor to decode a third syntax element to determine a lifting offset denominator value. In some implementations, to decode the bitstream based on the lifting offset value for each level of detail, the memory storing instructions, which when executed by the processor, may cause the processor to decode the bitstream based on the lifting offset numerator value and the lifting offset denominator value.

In some implementations, the first syntax element may indicate which type of lifting transform is enabled. In some implementations, the second syntax element may indicate the lifting offset numerator value. In some implementations, the third syntax element may indicate the lifting offset denominator value.

In some implementations, to decode the bitstream based on the lifting offset numerator value and the lifting offset denominator value, the memory storing instructions, which when executed by the processor, may cause the processor to decode a base mesh from the bitstream based on the lifting offset numerator value and the lifting offset denominator value.

In some implementations, the memory storing instructions, which when executed by the processor, may cause the processor to, in response to the first syntax element having a second value different than the first value, determine a lifting offset applied to lifting transform values is not enabled.

According to another aspect of the present disclosure, a decoder is provided. The decoder may include a processor and memory storing instructions. The memory storing instructions, which when executed by the processor, may cause the processor to decode a first syntax element. The memory storing instructions, which when executed by the processor, may cause the processor to, in response to the first syntax element having a first value and a linear lifting transform being enabled, decode a second syntax element. The memory storing instructions, which when executed by the processor, may cause the processor to, in response to the second syntax element having a second value, for a level-of-detail, decode a third syntax element to determine a lifting offset numerator value. The memory storing instructions, which when executed by the processor, may cause the processor to, in response to the second syntax element having a second value, for the level-of-detail, decode a fourth syntax element to determine a lifting offset denominator value. The memory storing instructions, which when executed by the processor, may cause the processor to, in response to the second syntax element having a second value, for the level-of-detail, decode a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, to decode the bitstream based on the lifting offset numerator value and the lifting offset denominator value, the memory storing instructions, which when executed by the processor, may cause the processor to decode a base-mesh displacement from the bitstream based on the lifting offset numerator value and the lifting offset denominator value.

In some implementations, the first value and the second value may be a same value.

In some implementations, the memory storing instructions, which when executed by the processor, may cause the processor to, in response to the second syntax element having a third value different than the second value, determine the lifting offset applied to lifting transform values is not enabled.

According to yet another aspect of the present disclosure, an apparatus for decoding is provided. The apparatus for decoding may include a processor and memory storing instructions. The memory storing instructions, which when executed by the processor, cause the processor to decode a first syntax element to determine which type of lifting transform is enabled. The memory storing instructions, which when executed by the processor, cause the processor to, in response to a linear lifting transform being enabled, decode a second syntax element to determine whether a lifting offset applied to lifting transform values is enabled. The memory storing instructions, which when executed by the processor, cause the processor to, in response to the lifting offset applied to the lifting transform values being enabled, decode a bitstream based on the lifting offset applied to the lifting transform values.

According to yet another aspect of the present disclosure, an apparatus for decoding is provided. The apparatus for decoding may include a processor and memory storing instructions. The memory storing instructions, which when executed by the processor, may cause the processor to decode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to decode a bitstream based on the lifting offset value for each level of detail.

According to yet another aspect of the present disclosure, an apparatus for decoding is provided. The apparatus for decoding may include a processor and memory storing instructions. The memory storing instructions, which when executed by the processor, may cause the processor to decode a first syntax element. The memory storing instructions, which when executed by the processor, may cause the processor to, in response to the first syntax element having a first value and a linear lifting transform being enabled, decode a second syntax element. The memory storing instructions, which when executed by the processor, may cause the processor to, in response to the second syntax element having a second value, for a level-of-detail, decode a third syntax element to determine a lifting offset numerator value. The memory storing instructions, which when executed by the processor, may cause the processor to, in response to the second syntax element having a second value, for the level-of-detail, decode a fourth syntax element to determine a lifting offset denominator value. The memory storing instructions, which when executed by the processor, may cause the processor to, in response to the second syntax element having a second value, for the level-of-detail, decode a bitstream based on the lifting offset numerator value and the lifting offset denominator value.

According to yet another aspect of the present disclosure, a non-transitory computer-readable medium storing instructions for a decoder is provided. The instructions, which when executed by the processor of the decoder, may cause the processor of the decoder to decode a first syntax element to determine which type of lifting transform is enabled. The instructions, which when executed by the processor of the decoder, may cause the processor of the decoder to, in response to a linear lifting transform being enabled, decode a second syntax element to determine whether a lifting offset applied to lifting transform values is enabled. The instructions, which when executed by the processor of the decoder, may cause the processor of the decoder to, in response to the lifting offset applied to the lifting transform values being enabled, decode a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, to decode the second syntax element to determine whether the lifting offset applied to lifting transform values is enabled, the instructions, which when executed by the processor of the decoder, may cause the processor of the decoder to, in response to the second syntax element having a first value, determine the lifting offset applied to lifting transform values is enabled. In some implementations, the lifting offset applied to the lifting transform values may be sent per level-of-detail.

In some implementations, in response to the linear lifting transform being enabled, to decode the second syntax element to determine whether the lifting offset applied to lifting transform values is enabled, the instructions, which when executed by the processor of the decoder, may cause the processor of the decoder to, in response to the second syntax element having a second value different than the first value, determine the lifting offset applied to lifting transform values is not enabled.

According to yet another aspect of the present disclosure, a non-transitory computer-readable medium storing instructions for a decoder is provided. The instructions, which when executed by the processor of the decoder, may cause the processor of the decoder to decode a first syntax element. The instructions, which when executed by the processor of the decoder, may cause the processor of the decoder to, in response to the first syntax element having a first value, determine a lifting offset value for each level-of-detail. The instructions, which when executed by the processor of the decoder, may cause the processor of the decoder to decode a bitstream based on the lifting offset value for each level of detail.

In some implementations, in response to the first syntax element having the first value, to determine the lifting offset value for each level-of-detail, the instructions, which when executed by the processor of the decoder, may cause the processor of the decoder to decode a second syntax element to determine a lifting offset numerator value. In some implementations, in response to the first syntax element having the first value, to determine the lifting offset value for each level-of-detail, the instructions, which when executed by the processor of the decoder, may cause the processor of the decoder to decode a third syntax element to determine a lifting offset denominator value. In some implementations, to decode the bitstream based on the lifting offset value for each level of detail, the instructions, which when executed by the processor of the decoder, may cause the processor of the decoder to decode the bitstream based on the lifting offset numerator value and the lifting offset denominator value.

In some implementations, the first syntax element may indicate which type of lifting transform is enabled. In some implementations, the second syntax element may indicate the lifting offset numerator value. In some implementations, the third syntax element may indicate the lifting offset denominator value.

In some implementations, to decode the bitstream based on the lifting offset numerator value and the lifting offset denominator value, the instructions, which when executed by the processor of the decoder, may cause the processor of the decoder to decode a base mesh from the bitstream based on the lifting offset numerator value and the lifting offset denominator value.

In some implementations, the instructions, which when executed by the processor of the decoder, may cause the processor of the decoder to, in response to the first syntax element having a second value different than the first value, determine a lifting offset applied to lifting transform values is not enabled.

According to yet another aspect of the present disclosure, a non-transitory computer-readable medium storing instructions for a decoder is provided. The instructions, which when executed by the processor of the decoder, may cause the processor of the decoder to decode a first syntax element. The instructions, which when executed by the processor of the decoder, may cause the processor of the decoder to, in response to the first syntax element having a first value and a linear lifting transform being enabled, decode a second syntax element. The instructions, which when executed by the processor of the decoder, may cause the processor of the decoder to, in response to the second syntax element having a second value, for a level-of-detail, decode a third syntax element to determine a lifting offset numerator value. The instructions, which when executed by the processor of the decoder, may cause the processor of the decoder to, in response to the second syntax element having a second value, for the level-of-detail, decode a fourth syntax element to determine a lifting offset denominator value. The instructions, which when executed by the processor of the decoder, may cause the processor of the decoder to, in response to the second syntax element having a second value, for the level-of-detail, decode a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, to decode the bitstream based on the lifting offset numerator value and the lifting offset denominator value, the instructions, which when executed by the processor of the decoder, may cause the processor of the decoder to decode a base-mesh displacement from the bitstream based on the lifting offset numerator value and the lifting offset denominator value.

In some implementations, the first value and the second value may be a same value.

In some implementations, the instructions, which when executed by the processor of the decoder, may cause the processor of the decoder to, in response to the second syntax element having a third value different than the second value, determine the lifting offset applied to lifting transform values is not enabled.

According to one aspect of the present disclosure, a method of encoding by an encoder is provided. The method may include encoding, by a processor, a first syntax element to determine which type of lifting transform is enabled. The method may include, in response to a linear lifting transform being enabled, encoding, by the processor, a second syntax element to determine whether a lifting offset applied to lifting transform values is enabled. The method may include, in response to the lifting offset applied to the lifting transform values being enabled, encoding, by the processor, a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, the encoding, by the processor, the second syntax element to determine whether the lifting offset applied to lifting transform values is enabled may include, in response to the second syntax element having a first value, determining, by the processor, the lifting offset applied to lifting transform values is enabled and sent per level-of-detail.

In some implementations, in response to the linear lifting transform being enabled, the encoding, by the processor, the second syntax element to determine whether the lifting offset applied to lifting transform values is enabled may include, in response to the second syntax element having a second value different than the first value, determining, by the processor, the lifting offset applied to lifting transform values is not enabled.

According to another aspect of the present disclosure, a method of encoding by an encoder is provided. The method may include encoding, by a processor, a first syntax element. The method may include, in response to the first syntax element having a first value, determining, by the processor, a lifting offset value for each level-of-detail. The method may include encoding, by the processor, a bitstream based on the lifting offset value for each level of detail.

In some implementations, in response to the first syntax element having the first value, the determining, by the processor, the lifting offset value for each level-of-detail may include encoding, by the processor, a second syntax element to determine a lifting offset numerator value. In some implementations, in response to the first syntax element having the first value, the determining, by the processor, the lifting offset value for each level-of-detail may include encoding, by the processor, a third syntax element to determine a lifting offset denominator value. In some implementations, the encoding, by the processor, the bitstream based on the lifting offset value for each level of detail may include encoding, by the processor, the bitstream based on the lifting offset numerator value and the lifting offset denominator value.

In some implementations, the first syntax element may indicate which type of lifting transform is enabled. In some implementations, the second syntax element may indicate the lifting offset numerator value. In some implementations, the third syntax element may indicate the lifting offset denominator value.

In some implementations, the encoding, by the processor, the bitstream based on the lifting offset numerator value and the lifting offset denominator value may include encoding, by the processor, a base mesh from the bitstream based on the lifting offset numerator value and the lifting offset denominator value.

In some implementations, the method may include, in response to the first syntax element having a second value different than the first value, determining, by the processor, a lifting offset applied to lifting transform values is not enabled.

According to a further aspect of the present disclosure, a method of encoding by an encoder is provided. The method may include encoding, by a processor, a first syntax element. The method may, in response to the first syntax element having a first value and a linear lifting transform being enabled, encoding, by the processor, a second syntax element. The method may include, in response to the second syntax element having a second value, for a level-of-detail, encoding, by the processor, a third syntax element to determine a lifting offset numerator value. The method may include, in response to the second syntax element having a second value, for the level-of-detail, encoding, by the processor, a fourth syntax element to determine a lifting offset denominator value. The method may include, in response to the second syntax element having a second value, for the level-of-detail, encoding, by the processor, a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, the encoding, by the processor, the bitstream based on the lifting offset numerator value and the lifting offset denominator value may include encoding, by the processor, a base-mesh displacement from the bitstream based on the lifting offset numerator value and the lifting offset denominator value.

In some implementations, the first value and the second value may be a same value.

In some implementations, the method may include, in response to the second syntax element having a third value different than the second value, determining, by the processor, the lifting offset applied to lifting transform values is not enabled.

According to yet another aspect of the present disclosure, an encoder is provided. The encoder may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, encode a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, to encode the second syntax element to determine whether the lifting offset applied to lifting transform values is enabled, the memory storing instructions, which when executed by the processor, may cause the processor to, in response to the second syntax element having a first value, determine the lifting offset applied to lifting transform values is enabled. In some implementations, the lifting offset applied to the lifting transform values may be sent per level-of-detail.

In some implementations, in response to the linear lifting transform being enabled, to encode the second syntax element to determine whether the lifting offset applied to lifting transform values is enabled, the memory storing instructions, which when executed by the processor, may cause the processor to, in response to the second syntax element having a second value different than the first value, determine the lifting offset applied to lifting transform values is not enabled.

According to still a further aspect of the present disclosure, an encoder is provided. The encoder may include a processor and memory storing instructions. The memory storing instructions, which when executed by the processor, may cause the processor to encode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to encode a bitstream based on the lifting offset value for each level of detail.

In some implementations, in response to the first syntax element having the first value, to determine the lifting offset value for each level-of-detail, the memory storing instructions, which when executed by the processor, may cause the processor to encode a second syntax element to determine a lifting offset numerator value. In some implementations, in response to the first syntax element having the first value, to determine the lifting offset value for each level-of-detail, the memory storing instructions, which when executed by the processor, may cause the processor to encode a third syntax element to determine a lifting offset denominator value. In some implementations, to encode the bitstream based on the lifting offset value for each level of detail, the memory storing instructions, which when executed by the processor, may cause the processor to encode the bitstream based on the lifting offset numerator value and the lifting offset denominator value.

In some implementations, the first syntax element may indicate which type of lifting transform is enabled. In some implementations, the second syntax element may indicate the lifting offset numerator value. In some implementations, the third syntax element may indicate the lifting offset denominator value.

In some implementations, to encode the bitstream based on the lifting offset numerator value and the lifting offset denominator value, the memory storing instructions, which when executed by the processor, may cause the processor to encode a base mesh from the bitstream based on the lifting offset numerator value and the lifting offset denominator value.

In some implementations, the memory storing instructions, which when executed by the processor, may cause the processor to, in response to the first syntax element having a second value different than the first value, determine a lifting offset applied to lifting transform values is not enabled.

According to another aspect of the present disclosure, an encoder is provided. The encoder may include a processor and memory storing instructions. The memory storing instructions, which when executed by the processor, may cause the processor to encode a first syntax element. The memory storing instructions, which when executed by the processor, may cause the processor to, in response to the first syntax element having a first value and a linear lifting transform being enabled, encode a second syntax element. The memory storing instructions, which when executed by the processor, may cause the processor to, in response to the second syntax element having a second value, for a level-of-detail, encode a third syntax element to determine a lifting offset numerator value. The memory storing instructions, which when executed by the processor, may cause the processor to, in response to the second syntax element having a second value, for the level-of-detail, encode a fourth syntax element to determine a lifting offset denominator value. The memory storing instructions, which when executed by the processor, may cause the processor to, in response to the second syntax element having a second value, for the level-of-detail, encode a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, to encode the bitstream based on the lifting offset numerator value and the lifting offset denominator value, the memory storing instructions, which when executed by the processor, may cause the processor to encode a base-mesh displacement from the bitstream based on the lifting offset numerator value and the lifting offset denominator value.

In some implementations, the first value and the second value may be a same value.

In some implementations, the memory storing instructions, which when executed by the processor, may cause the processor to, in response to the second syntax element having a third value different than the second value, determine the lifting offset applied to lifting transform values is not enabled.

According to yet another aspect of the present disclosure, an apparatus for encoding is provided. The apparatus for encoding may include a processor and memory storing instructions. The memory storing instructions, which when executed by the processor, cause the processor to encode a first syntax element to determine which type of lifting transform is enabled. The memory storing instructions, which when executed by the processor, cause the processor to, in response to a linear lifting transform being enabled, encode a second syntax element to determine whether a lifting offset applied to lifting transform values is enabled. The memory storing instructions, which when executed by the processor, cause the processor to, in response to the lifting offset applied to the lifting transform values being enabled, encode a bitstream based on the lifting offset applied to the lifting transform values.

According to yet another aspect of the present disclosure, an apparatus for encoding is provided. The apparatus for encoding may include a processor and memory storing instructions. The memory storing instructions, which when executed by the processor, may cause the processor to encode a first syntax element. The memory storing instructions, which when executed by the processor, may cause the processor to, in response to the first syntax element having a first value, determine a lifting offset value for each level-of-detail. The memory storing instructions, which when executed by the processor, may cause the processor to encode a bitstream based on the lifting offset value for each level of detail.

According to yet another aspect of the present disclosure, an apparatus for encoding is provided. The apparatus for encoding may include a processor and memory storing instructions. The memory storing instructions, which when executed by the processor, may cause the processor to encode a first syntax element. The memory storing instructions, which when executed by the processor, may cause the processor to, in response to the first syntax element having a first value and a linear lifting transform being enabled, encode a second syntax element. The memory storing instructions, which when executed by the processor, may cause the processor to, in response to the second syntax element having a second value, for a level-of-detail, encode a third syntax element to determine a lifting offset numerator value. The memory storing instructions, which when executed by the processor, may cause the processor to, in response to the second syntax element having a second value, for the level-of-detail, encode a fourth syntax element to determine a lifting offset denominator value. The memory storing instructions, which when executed by the processor, may cause the processor to, in response to the second syntax element having a second value, for the level-of-detail, encode a bitstream based on the lifting offset numerator value and the lifting offset denominator value.

According to yet another aspect of the present disclosure, a non-transitory computer-readable medium storing instructions for an encoder is provided. The instructions, which when executed by the processor of the encoder, may cause the processor of the encoder to encode a first syntax element to determine which type of lifting transform is enabled. The instructions, which when executed by the processor of the encoder, may cause the processor of the encoder to, in response to a linear lifting transform being enabled, encode a second syntax element to determine whether a lifting offset applied to lifting transform values is enabled. The instructions, which when executed by the processor of the encoder, may cause the processor of the encoder to, in response to the lifting offset applied to the lifting transform values being enabled, encode a bitstream based on the lifting offset applied to the lifting transform values.

In some implementations, the first syntax element may indicate which type of lifting transform is enabled. In some implementations, the second syntax element indicates whether the lifting offset applied to the lifting transform values is enabled.

In some implementations, in response to the linear lifting transform being enabled, to encode the second syntax element to determine whether the lifting offset applied to lifting transform values is enabled, the instructions, which when executed by the processor of the encoder, may cause the processor of the encoder to, in response to the second syntax element having a first value, determine the lifting offset applied to lifting transform values is enabled. In some implementations, the lifting offset applied to the lifting transform values may be sent per level-of-detail.

In some implementations, in response to the linear lifting transform being enabled, to encode the second syntax element to determine whether the lifting offset applied to lifting transform values is enabled, the instructions, which when executed by the processor of the encoder, may cause the processor of the encoder to, in response to the second syntax element having a second value different than the first value, determine the lifting offset applied to lifting transform values is not enabled.

According to yet another aspect of the present disclosure, a non-transitory computer-readable medium storing instructions for an encoder is provided. The instructions, which when executed by the processor of the encoder, may cause the processor of the encoder to encode a first syntax element. The instructions, which when executed by the processor of the encoder, may cause the processor of the encoder to, in response to the first syntax element having a first value, determine a lifting offset value for each level-of-detail. The instructions, which when executed by the processor of the encoder, may cause the processor of the encoder to encode a bitstream based on the lifting offset value for each level of detail.

In some implementations, in response to the first syntax element having the first value, to determine the lifting offset value for each level-of-detail, the instructions, which when executed by the processor of the encoder, may cause the processor of the encoder to encode a second syntax element to determine a lifting offset numerator value. In some implementations, in response to the first syntax element having the first value, to determine the lifting offset value for each level-of-detail, the instructions, which when executed by the processor of the encoder, may cause the processor of the encoder to encode a third syntax element to determine a lifting offset denominator value. In some implementations, to encode the bitstream based on the lifting offset value for each level of detail, the instructions, which when executed by the processor of the encoder, may cause the processor of the encoder to encode the bitstream based on the lifting offset numerator value and the lifting offset denominator value.

In some implementations, the first syntax element may indicate which type of lifting transform is enabled. In some implementations, the second syntax element may indicate the lifting offset numerator value. In some implementations, the third syntax element may indicate the lifting offset denominator value.

In some implementations, to encode the bitstream based on the lifting offset numerator value and the lifting offset denominator value, the instructions, which when executed by the processor of the encoder, may cause the processor of the encoder to encode a base mesh from the bitstream based on the lifting offset numerator value and the lifting offset denominator value.

In some implementations, the instructions, which when executed by the processor of the encoder, may cause the processor of the encoder to, in response to the first syntax element having a second value different than the first value, determine a lifting offset applied to lifting transform values is not enabled.

According to yet another aspect of the present disclosure, a non-transitory computer-readable medium storing instructions for an encoder is provided. The instructions, which when executed by the processor of the encoder, may cause the processor of the encoder to encode a first syntax element. The instructions, which when executed by the processor of the encoder, may cause the processor of the encoder to, in response to the first syntax element having a first value and a linear lifting transform being enabled, encode a second syntax element. The instructions, which when executed by the processor of the encoder, may cause the processor of the encoder to, in response to the second syntax element having a second value, for a level-of-detail, encode a third syntax element to determine a lifting offset numerator value. The instructions, which when executed by the processor of the encoder, may cause the processor of the encoder to, in response to the second syntax element having a second value, for the level-of-detail, encode a fourth syntax element to determine a lifting offset denominator value. The instructions, which when executed by the processor of the encoder, may cause the processor of the encoder to, in response to the second syntax element having a second value, for the level-of-detail, encode a bitstream based on the lifting offset numerator value and the lifting offset denominator value.

In some implementations, the first syntax element may indicate which type of lifting transform is enabled. In some implementations, the second syntax element may indicate whether a lifting offset value is updated. In some implementations, the third syntax element may indicate the lifting offset numerator value. In some implementations, the fourth syntax element may indicate the lifting offset denominator value.

In some implementations, in response to the second syntax element having a second value, for the level-of-detail, to encode the bitstream based on the lifting offset numerator value and the lifting offset denominator value, the instructions, which when executed by the processor of the encoder, may cause the processor of the encoder to encode a base-mesh displacement from the bitstream based on the lifting offset numerator value and the lifting offset denominator value.

In some implementations, the first value and the second value may be a same value.

In some implementations, the instructions, which when executed by the processor of the encoder, may cause the processor of the encoder to, in response to the second syntax element having a third value different than the second value, determine the lifting offset applied to lifting transform values is not enabled.

According to another aspect of the present disclosure, a method of decoding by a decoder is provided. The method may include decoding, by a processor, a first syntax element to determine which type of lifting transform is enabled. The method may include, in response to a linear lifting transform being enabled, decoding, by the processor, a second syntax element to determine whether a lifting offset applied to lifting transform values is enabled. The method may include in response to the lifting offset applied to the lifting transform values being enabled, for a level-of-detail, decoding, by the processor, a third syntax element to determine a lifting offset numerator value. The method may include in response to the lifting offset applied to the lifting transform values being enabled, for a level-of-detail, decoding, by the processor, a fourth syntax element to determine a lifting offset denominator value. The method may include in response to the lifting offset applied to the lifting transform values being enabled, for a level-of-detail, decoding, by the processor, a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, the decoding, by the processor, the second syntax element to determine whether the lifting offset applied to lifting transform values is enabled may include, in response to the second syntax element having a first value, determining, by the processor, the lifting offset applied to the lifting transform values is enabled.

In some implementations, in response to the linear lifting transform being enabled, the decoding, by the processor, the second syntax element to determine whether the lifting offset applied to lifting transform values is enabled may include, in response to the second syntax element having a second value different than the first value, determining, by the processor, the lifting offset applied to lifting transform values is not enabled.

In some implementations, in response to the lifting offset applied to the lifting transform values being enabled, for the level-of-detail, the decoding, by the processor, the bitstream based on the lifting offset numerator value and the lifting offset denominator value may include decoding, by the processor, a base-mesh displacement from the bitstream based on the lifting offset numerator value and the lifting offset denominator value.

According to a further aspect of the present disclosure, a decoder is provided. The decoder may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, decode a third syntax element to determine a lifting offset numerator value. The memory storing instructions, which when executed by the processor, may cause the processor to, in response to the lifting offset applied to the lifting transform values being enabled, for a level-of-detail, decode a fourth syntax element to determine a lifting offset denominator value. The memory storing instructions, which when executed by the processor, may cause the processor to, in response to the lifting offset applied to the lifting transform values being enabled, for a level-of-detail, decode a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, to decode the second syntax element to determine whether the lifting offset applied to lifting transform values is enabled, the memory storing instructions, which when executed by the processor, may further cause the processor to, in response to the second syntax element having a first value, determine the lifting offset applied to the lifting transform values is enabled.

In some implementations, in response to the linear lifting transform being enabled, to decode the second syntax element to determine whether the lifting offset applied to lifting transform values is enabled, the memory storing instructions, which when executed by the processor, may further cause the processor to, in response to the second syntax element having a second value different than the first value, determine the lifting offset applied to lifting transform values is not enabled.

In some implementations, in response to the lifting offset applied to the lifting transform values being enabled, for the level-of-detail, to decode the bitstream based on the lifting offset numerator value and the lifting offset denominator value, the memory storing instructions, which when executed by the processor, may cause the processor to decode a base-mesh displacement from the bitstream based on the lifting offset numerator value and the lifting offset denominator value.

According to a further aspect of the present disclosure, an apparatus for decoding is provided. The apparatus for decoding may include a processor and memory storing instructions. The memory storing instructions, which when executed by the processor, may cause the processor to decode a first syntax element to determine which type of lifting transform is enabled. The memory storing instructions, which when executed by the processor, may cause the processor to, in response to a linear lifting transform being enabled, decode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, decode a third syntax element to determine a lifting offset numerator value. The memory storing instructions, which when executed by the processor, may cause the processor to, in response to the lifting offset applied to the lifting transform values being enabled, for a level-of-detail, decode a fourth syntax element to determine a lifting offset denominator value. The memory storing instructions, which when executed by the processor, may cause the processor to, in response to the lifting offset applied to the lifting transform values being enabled, for a level-of-detail, decode a bitstream based on the lifting offset numerator value and the lifting offset denominator value.

According to a further aspect of the present disclosure, a non-transitory computer-readable medium storing instructions for a decoder is provided is provided. The instructions, which when executed by the processor of the decoder, may cause the processor of the decoder to decode a first syntax element to determine which type of lifting transform is enabled. The instructions, which when executed by the processor of the decoder, may cause the processor of the decoder to, in response to a linear lifting transform being enabled, decode a second syntax element to determine whether a lifting offset applied to lifting transform values is enabled. The instructions, which when executed by the processor of the decoder, may cause the processor of the decoder to, in response to the lifting offset applied to the lifting transform values being enabled, for a level-of-detail, decode a third syntax element to determine a lifting offset numerator value. The instructions, which when executed by the processor of the decoder, may cause the processor of the decoder to, in response to the lifting offset applied to the lifting transform values being enabled, for a level-of-detail, decode a fourth syntax element to determine a lifting offset denominator value. The instructions, which when executed by the processor of the decoder, may cause the processor of the decoder to, in response to the lifting offset applied to the lifting transform values being enabled, for a level-of-detail, decode a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, to decode the second syntax element to determine whether the lifting offset applied to lifting transform values is enabled, the instructions, which when executed by the processor of the decoder, may further cause the processor of the decoder to, in response to the second syntax element having a first value, determine the lifting offset applied to the lifting transform values is enabled.

In some implementations, in response to the linear lifting transform being enabled, to decode the second syntax element to determine whether the lifting offset applied to lifting transform values is enabled, the instructions, which when executed by the processor of the decoder, may further cause the processor of the decoder to, in response to the second syntax element having a second value different than the first value, determine the lifting offset applied to lifting transform values is not enabled.

In some implementations, in response to the lifting offset applied to the lifting transform values being enabled, for the level-of-detail, to decode the bitstream based on the lifting offset numerator value and the lifting offset denominator value, the instructions, which when executed by the processor of the decoder, may cause the processor of the decoder to decode a base-mesh displacement from the bitstream based on the lifting offset numerator value and the lifting offset denominator value.

According to another aspect of the present disclosure, a method of encoding by an encoder is provided. The method may include encoding, by a processor, a first syntax element to determine which type of lifting transform is enabled. The method may include, in response to a linear lifting transform being enabled, encoding, by the processor, a second syntax element to determine whether a lifting offset applied to lifting transform values is enabled. The method may include in response to the lifting offset applied to the lifting transform values being enabled, for a level-of-detail, encoding, by the processor, a third syntax element to determine a lifting offset numerator value. The method may include in response to the lifting offset applied to the lifting transform values being enabled, for a level-of-detail, encoding, by the processor, a fourth syntax element to determine a lifting offset denominator value. The method may include in response to the lifting offset applied to the lifting transform values being enabled, for a level-of-detail, encoding, by the processor, a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, the encoding, by the processor, the second syntax element to determine whether the lifting offset applied to lifting transform values is enabled may include, in response to the second syntax element having a first value, determining, by the processor, the lifting offset applied to the lifting transform values is enabled.

In some implementations, in response to the linear lifting transform being enabled, the encoding, by the processor, the second syntax element to determine whether the lifting offset applied to lifting transform values is enabled may include, in response to the second syntax element having a second value different than the first value, determining, by the processor, the lifting offset applied to lifting transform values is not enabled.

In some implementations, in response to the lifting offset applied to the lifting transform values being enabled, for the level-of-detail, the encoding, by the processor, the bitstream based on the lifting offset numerator value and the lifting offset denominator value may include encoding, by the processor, a base-mesh displacement from the bitstream based on the lifting offset numerator value and the lifting offset denominator value.

According to a further aspect of the present disclosure, an encoder is provided. The encoder may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, encode a third syntax element to determine a lifting offset numerator value. The memory storing instructions, which when executed by the processor, may cause the processor to, in response to the lifting offset applied to the lifting transform values being enabled, for a level-of-detail, encode a fourth syntax element to determine a lifting offset denominator value. The memory storing instructions, which when executed by the processor, may cause the processor to, in response to the lifting offset applied to the lifting transform values being enabled, for a level-of-detail, encode a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, to encode the second syntax element to determine whether the lifting offset applied to lifting transform values is enabled, the memory storing instructions, which when executed by the processor, may further cause the processor to, in response to the second syntax element having a first value, determine the lifting offset applied to the lifting transform values is enabled.

In some implementations, in response to the linear lifting transform being enabled, to encode the second syntax element to determine whether the lifting offset applied to lifting transform values is enabled, the memory storing instructions, which when executed by the processor, may further cause the processor to, in response to the second syntax element having a second value different than the first value, determine the lifting offset applied to lifting transform values is not enabled.

In some implementations, in response to the lifting offset applied to the lifting transform values being enabled, for the level-of-detail, to encode the bitstream based on the lifting offset numerator value and the lifting offset denominator value, the memory storing instructions, which when executed by the processor, may cause the processor to encode a base-mesh displacement from the bitstream based on the lifting offset numerator value and the lifting offset denominator value.

According to a further aspect of the present disclosure, an apparatus for encoding is provided. The apparatus for encoding may include a processor and memory storing instructions. The memory storing instructions, which when executed by the processor, may cause the processor to encode a first syntax element to determine which type of lifting transform is enabled. The memory storing instructions, which when executed by the processor, may cause the processor to, in response to a linear lifting transform being enabled, encode a second syntax element to determine whether a lifting offset applied to lifting transform values is enabled. The memory storing instructions, which when executed by the processor, may cause the processor to, in response to the lifting offset applied to the lifting transform values being enabled, for a level-of-detail, encode a third syntax element to determine a lifting offset numerator value. The memory storing instructions, which when executed by the processor, may cause the processor to, in response to the lifting offset applied to the lifting transform values being enabled, for a level-of-detail, encode a fourth syntax element to determine a lifting offset denominator value. The memory storing instructions, which when executed by the processor, may cause the processor to, in response to the lifting offset applied to the lifting transform values being enabled, for a level-of-detail, encode a bitstream based on the lifting offset numerator value and the lifting offset denominator value.

According to a further aspect of the present disclosure, a non-transitory computer-readable medium storing instructions for an encoder is provided is provided. The instructions, which when executed by the processor of the encoder, may cause the processor of the encoder to encode a first syntax element to determine which type of lifting transform is enabled. The instructions, which when executed by the processor of the encoder, may cause the processor of the encoder to, in response to a linear lifting transform being enabled, encode a second syntax element to determine whether a lifting offset applied to lifting transform values is enabled. The instructions, which when executed by the processor of the encoder, may cause the processor of the encoder to, in response to the lifting offset applied to the lifting transform values being enabled, for a level-of-detail, encode a third syntax element to determine a lifting offset numerator value. The instructions, which when executed by the processor of the encoder, may cause the processor of the encoder to, in response to the lifting offset applied to the lifting transform values being enabled, for a level-of-detail, encode a fourth syntax element to determine a lifting offset denominator value. The instructions, which when executed by the processor of the encoder, may cause the processor of the encoder to, in response to the lifting offset applied to the lifting transform values being enabled, for a level-of-detail, encode a bitstream based on the lifting offset numerator value and the lifting offset denominator value.

In some implementations, the first syntax element may indicate which type of lifting transform is enabled. In some implementations, the second syntax element may indicate whether a lifting offset applied to the lifting transform values is enabled. In some implementations, the third syntax element may indicate the lifting offset numerator value. In some implementations, the fourth syntax element may indicate the lifting offset denominator value.

In some implementations, in response to the linear lifting transform being enabled, to encode the second syntax element to determine whether the lifting offset applied to lifting transform values is enabled, the instructions, which when executed by the processor of the encoder, may further cause the processor of the encoder to, in response to the second syntax element having a first value, determine the lifting offset applied to the lifting transform values is enabled.

In some implementations, in response to the linear lifting transform being enabled, to encode the second syntax element to determine whether the lifting offset applied to lifting transform values is enabled, the instructions, which when executed by the processor of the encoder, may further cause the processor of the encoder to, in response to the second syntax element having a second value different than the first value, determine the lifting offset applied to lifting transform values is not enabled.

In some implementations, in response to the lifting offset applied to the lifting transform values being enabled, for the level-of-detail, to encode the bitstream based on the lifting offset numerator value and the lifting offset denominator value, the instructions, which when executed by the processor of the encoder, may cause the processor of the encoder to encode a base-mesh displacement from the bitstream based on the lifting offset numerator value and the lifting offset denominator value.

According to yet another aspect of the present disclosure, a method of transmitting a bitstream is provided. The bitstream may be decoded or generated using one or more operations described herein.

In a first clause, provided is a method of decoding by a decoder, and the method includes:
decoding, by a processor, a first syntax element to determine which type of lifting transform is enabled;
in response to a linear lifting transform being enabled, decoding, by the processor, a second syntax element to determine whether a lifting offset applied to lifting transform values is enabled; and
in response to the lifting offset applied to the lifting transform values being enabled, for a level-of-detail,
   decoding, by the processor, a third syntax element to determine a lifting offset numerator value;
   decoding, by the processor, a fourth syntax element to determine a lifting offset denominator value; and
   decoding, by the processor, a bitstream based on the lifting offset numerator value and the lifting offset denominator value.

In a second clause, the method of the first clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In a third clause, the method of the first clause, where, in response to a linear lifting transform being enabled, the decoding, by the processor, the second syntax element to determine whether the lifting offset applied to lifting transform values is enabled includes:
in response to the second syntax element having a first value, determining, by the processor, the lifting offset applied to the lifting transform values is enabled.

In a fourth clause, the method of the third clause, where, in response to a linear lifting transform being enabled, the decoding, by the processor, the second syntax element to determine whether the lifting offset applied to lifting transform values is enabled includes:
in response to the second syntax element having a second value different than the first value, determining, by the processor, the lifting offset applied to lifting transform values is not enabled.

In a fifth clause, the method of the first clause, where, in response to the lifting offset applied to the lifting transform values being enabled, for the level-of-detail, the decoding, by the processor, the bitstream based on the lifting offset numerator value and the lifting offset denominator value includes:
decoding, by the processor, a base-mesh displacement from the bitstream based on the lifting offset numerator value and the lifting offset denominator value.

In a sixth clause, provided is a decoder, and the decoder includes:
a processor; and memory storing instructions, which when executed by the processor, cause the processor to:
decode a first syntax element to determine which type of lifting transform is enabled;
in response to a linear lifting transform being enabled, decode a second syntax element to determine whether a lifting offset applied to lifting transform values is enabled; and
in response to the lifting offset applied to the lifting transform values being enabled, for a level-of-detail,
   decode a third syntax element to determine a lifting offset numerator value;
   decode a fourth syntax element to determine a lifting offset denominator value; and
   decode a bitstream based on the lifting offset numerator value and the lifting offset denominator value.

In a seventh clause, the decoder of the sixth clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In an eighth clause, the decoder of the sixth clause, where, in response to a linear lifting transform being enabled, to decode the second syntax element to determine whether the lifting offset applied to lifting transform values is enabled, the memory storing instructions, which when executed by the processor, further cause the processor to:
in response to the second syntax element having a first value, determine the lifting offset applied to the lifting transform values is enabled.

In a ninth clause, the decoder of the eighth clause, where, in response to a linear lifting transform being enabled, to decode the second syntax element to determine whether the lifting offset applied to lifting transform values is enabled, the memory storing instructions, which when executed by the processor, further cause the processor to:
in response to the second syntax element having a second value different than the first value, determine the lifting offset applied to lifting transform values is not enabled.

In a tenth clause, the decoder of the sixth clause, where, in response to the lifting offset applied to the lifting transform values being enabled, for the level-of-detail, to decode the bitstream based on the lifting offset numerator value and the lifting offset denominator value, the memory storing instructions, which when executed by the processor, cause the processor to: decode a base-mesh displacement from the bitstream based on the lifting offset numerator value and the lifting offset denominator value.

In an eleventh clause, provided is an apparatus for decoding, and the apparatus includes:
a processor; and memory storing instructions, which when executed by the processor, cause the processor to:
decode a first syntax element to determine which type of lifting transform is enabled;
in response to a linear lifting transform being enabled, decode a second syntax element to determine whether a lifting offset applied to lifting transform values is enabled; and
in response to the lifting offset applied to the lifting transform values being enabled, for a level-of-detail,
   decode a third syntax element to determine a lifting offset numerator value;
   decode a fourth syntax element to determine a lifting offset denominator value; and
   decode a bitstream based on the lifting offset numerator value and the lifting offset denominator value.

In a twelfth clause, provided is a non-transitory computer-readable medium storing instructions, which when executed by a processor of a decoder, cause the processor of the decoder to:
decode a first syntax element to determine which type of lifting transform is enabled;
in response to a linear lifting transform being enabled, decode a second syntax element to determine whether a lifting offset applied to lifting transform values is enabled; and
in response to the lifting offset applied to the lifting transform values being enabled, for a level-of-detail,
   decode a third syntax element to determine a lifting offset numerator value;
   decode a fourth syntax element to determine a lifting offset denominator value; and
   decode a bitstream based on the lifting offset numerator value and the lifting offset denominator value.

In a thirteenth clause, the non-transitory computer-readable medium of the twelfth clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In a fourteenth clause, the non-transitory computer-readable medium of the twelfth clause, where, in response to a linear lifting transform being enabled, to decode the second syntax element to determine whether the lifting offset applied to lifting transform values is enabled, the instructions, which when executed by the processor of the decoder, further cause the processor of the decoder to:
in response to the second syntax element having a first value, determine the lifting offset applied to the lifting transform values is enabled.

In a fifteenth clause, the non-transitory computer-readable medium of the fourteenth clause, where, in response to a linear lifting transform being enabled, to decode the second syntax element to determine whether the lifting offset applied to lifting transform values is enabled, the instructions, which when executed by the processor of the decoder, further cause the processor of the decoder to:
in response to the second syntax element having a second value different than the first value, determine the lifting offset applied to lifting transform values is not enabled.

In a sixteenth clause, the non-transitory computer-readable medium of the twelfth clause, where, in response to the lifting offset applied to the lifting transform values being enabled, for the level-of-detail, to decode the bitstream based on the lifting offset numerator value and the lifting offset denominator value, the instructions, which when executed by the processor of the decoder, cause the processor of the decoder to:
decode a base-mesh displacement from the bitstream based on the lifting offset numerator value and the lifting offset denominator value.

In a seventeenth clause, provided is a method of encoding by an encoder, and the method includes:
encoding, by a processor, a first syntax element to determine which type of lifting transform is enabled;
in response to a linear lifting transform being enabled, encoding, by the processor, a second syntax element to determine whether a lifting offset applied to lifting transform values is enabled; and
in response to the lifting offset applied to the lifting transform values being enabled, for a level-of-detail,
   encoding, by the processor, a third syntax element to determine a lifting offset numerator value;
   encoding, by the processor, a fourth syntax element to determine a lifting offset denominator value; and
   encoding, by the processor, a bitstream based on the lifting offset numerator value and the lifting offset denominator value.

In a eighteenth clause, the method of the seventeenth clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In a nineteenth clause, the method of the seventeenth clause, where, in response to a linear lifting transform being enabled, the decoding, by the processor, the second syntax element to determine whether the lifting offset applied to lifting transform values is enabled includes:
in response to the second syntax element having a first value, determining, by the processor, the lifting offset applied to the lifting transform values is enabled.

In a twentieth clause, the method of the nineteenth clause, where, in response to a linear lifting transform being enabled, the decoding, by the processor, the second syntax element to determine whether the lifting offset applied to lifting transform values is enabled includes:
in response to the second syntax element having a second value different than the first value, determining, by the processor, the lifting offset applied to lifting transform values is not enabled.

In a twenty-first clause, the method of the seventeenth clause, where, in response to the lifting offset applied to the lifting transform values being enabled, for the level-of-detail, the encoding, by the processor, the bitstream based on the lifting offset numerator value and the lifting offset denominator value includes:
encoding, by the processor, a base-mesh displacement from the bitstream based on the lifting offset numerator value and the lifting offset denominator value.

In a twenty-second clause, provided is an encoder, and the encoder includes:
a processor; and memory storing instructions, which when executed by the processor, cause the processor to:
encode a first syntax element to determine which type of lifting transform is enabled;
in response to a linear lifting transform being enabled, encode a second syntax element to determine whether a lifting offset applied to lifting transform values is enabled; and
in response to the lifting offset applied to the lifting transform values being enabled, for a level-of-detail,
   encode a third syntax element to determine a lifting offset numerator value;
   encode a fourth syntax element to determine a lifting offset denominator value; and
   encode a bitstream based on the lifting offset numerator value and the lifting offset denominator value.

In a twenty-third clause, the encoder of the twenty-second clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In a twenty-fourth clause, the encoder of the twenty-second clause, where, in response to a linear lifting transform being enabled, to decode the second syntax element to determine whether the lifting offset applied to lifting transform values is enabled, the memory storing instructions, which when executed by the processor, further cause the processor to:
in response to the second syntax element having a first value, determine the lifting offset applied to the lifting transform values is enabled.

In a twenty-fifth clause, the encoder of the twenty-fourth clause, where, in response to a linear lifting transform being enabled, to decode the second syntax element to determine whether the lifting offset applied to lifting transform values is enabled, the memory storing instructions, which when executed by the processor, further cause the processor to:
in response to the second syntax element having a second value different than the first value, determine the lifting offset applied to lifting transform values is not enabled.

In a twenty-sixth clause, the encoder of the twenty-fourth clause, where, in response to the lifting offset applied to the lifting transform values being enabled, for the level-of-detail, to encode the bitstream based on the lifting offset numerator value and the lifting offset denominator value, the memory storing instructions, which when executed by the processor, cause the processor to:
encode a base-mesh displacement from the bitstream based on the lifting offset numerator value and the lifting offset denominator value.

In a twenty-seventh clause, provided is an apparatus for encoding, and the apparatus includes:
a processor; and memory storing instructions, which when executed by the processor, cause the processor to:
encode a first syntax element to determine which type of lifting transform is enabled;
in response to a linear lifting transform being enabled, encode a second syntax element to determine whether a lifting offset applied to lifting transform values is enabled; and
in response to the lifting offset applied to the lifting transform values being enabled, for a level-of-detail,
   encode a third syntax element to determine a lifting offset numerator value;
   encode a fourth syntax element to determine a lifting offset denominator value; and
   encode a bitstream based on the lifting offset numerator value and the lifting offset denominator value.

In a twenty-eighth clause, provided is non-transitory computer-readable medium storing instructions, which when executed by a processor of an encoder, cause the processor of the encoder to:
encode a first syntax element to determine which type of lifting transform is enabled;
in response to a linear lifting transform being enabled, encode a second syntax element to determine whether a lifting offset applied to lifting transform values is enabled; and
in response to the lifting offset applied to the lifting transform values being enabled, for a level-of-detail,
   encode a third syntax element to determine a lifting offset numerator value;
   encode a fourth syntax element to determine a lifting offset denominator value; and
   encode a bitstream based on the lifting offset numerator value and the lifting offset denominator value.

In a twenty-ninth clause, the non-transitory computer-readable medium of the twenty-eighth clause, the first syntax element indicates which type of lifting transform is enabled, the second syntax element indicates whether a lifting offset applied to the lifting transform values is enabled, the third syntax element indicates the lifting offset numerator value, and the fourth syntax element indicates the lifting offset denominator value.

In a thirtieth clause, the non-transitory computer-readable medium of the twenty-eighth clause, where, in response to a linear lifting transform being enabled, to decode the second syntax element to determine whether the lifting offset applied to lifting transform values is enabled, the instructions, which when executed by the processor of the encoder, further cause the processor of the encoder to:
in response to the second syntax element having a first value, determine the lifting offset applied to the lifting transform values is enabled.

In a thirty-first clause, the non-transitory computer-readable medium of the thirtieth clause, where, in response to a linear lifting transform being enabled, to decode the second syntax element to determine whether the lifting offset applied to lifting transform values is enabled, the instructions, which when executed by the processor of the encoder, further cause the processor of the encoder to:
in response to the second syntax element having a second value different than the first value, determine the lifting offset applied to lifting transform values is not enabled.

In a thirty-second clause, the non-transitory computer-readable medium of the twenty-eighth clause, where, in response to the lifting offset applied to the lifting transform values being enabled, for the level-of-detail, to encode the bitstream based on the lifting offset numerator value and the lifting offset denominator value, the instructions, which when executed by the processor of the encoder, cause the processor of the encoder to:
encode a base-mesh displacement from the bitstream based on the lifting offset numerator value and the lifting offset denominator value.

In a thirty-third clause, provided is method of transmitting a bitstream, where the bitstream is decoded according to the method as claimed in any one of the first to fifth clauses, or the bitstream is generated according to the method as claimed in any one of any the seventeenth to twenty-first clauses.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of decoding by a decoder, comprising:
decoding, by a processor, a first syntax element to determine which type of lifting transform is enabled;
in response to a linear lifting transform being enabled, decoding, by the processor, a second syntax element to determine whether a lifting offset applied to lifting transform values is enabled; and
in response to the lifting offset applied to the lifting transform values being enabled, for a level-of-detail,
decoding, by the processor, a third syntax element to determine a lifting offset numerator value;
decoding, by the processor, a fourth syntax element to determine a lifting offset denominator value; and
decoding, by the processor, a bitstream based on the lifting offset numerator value and the lifting offset denominator value.

2. The method of claim 1, wherein:
the first syntax element indicates which type of lifting transform is enabled,
the second syntax element indicates whether a lifting offset applied to the lifting transform values is enabled,
the third syntax element indicates the lifting offset numerator value, and
the fourth syntax element indicates the lifting offset denominator value.

3. The method of claim 1, wherein, in response to a linear lifting transform being enabled, the decoding, by the processor, the second syntax element to determine whether the lifting offset applied to lifting transform values is enabled comprises:
in response to the second syntax element having a first value, determining, by the processor, the lifting offset applied to the lifting transform values is enabled.

4. The method of claim 3, wherein, in response to a linear lifting transform being enabled, the decoding, by the processor, the second syntax element to determine whether the lifting offset applied to lifting transform values is enabled comprises:
in response to the second syntax element having a second value different than the first value, determining, by the processor, the lifting offset applied to lifting transform values is not enabled.

5. The method of claim 1, wherein, in response to the lifting offset applied to the lifting transform values being enabled, for the level-of-detail, the decoding, by the processor, the bitstream based on the lifting offset numerator value and the lifting offset denominator value comprises:
decoding, by the processor, a base-mesh displacement from the bitstream based on the lifting offset numerator value and the lifting offset denominator value.

6. A decoder, comprising:
a processor; and
memory storing instructions, which when executed by the processor, cause the processor to:
decode a first syntax element to determine which type of lifting transform is enabled;
in response to a linear lifting transform being enabled, decode a second syntax element to determine whether a lifting offset applied to lifting transform values is enabled; and
in response to the lifting offset applied to the lifting transform values being enabled, for a level-of-detail,
decode a third syntax element to determine a lifting offset numerator value;
decode a fourth syntax element to determine a lifting offset denominator value; and
decode a bitstream based on the lifting offset numerator value and the lifting offset denominator value.

7. The decoder of claim 6, wherein:
the first syntax element indicates which type of lifting transform is enabled,
the second syntax element indicates whether a lifting offset applied to the lifting transform values is enabled,
the third syntax element indicates the lifting offset numerator value, and
the fourth syntax element indicates the lifting offset denominator value.

8. The decoder of claim 6, wherein, in response to a linear lifting transform being enabled, to decode the second syntax element to determine whether the lifting offset applied to lifting transform values is enabled, the memory storing instructions, which when executed by the processor, further cause the processor to:
in response to the second syntax element having a first value, determine the lifting offset applied to the lifting transform values is enabled.

9. The decoder of claim 8, wherein, in response to a linear lifting transform being enabled, to decode the second syntax element to determine whether the lifting offset applied to lifting transform values is enabled, the memory storing instructions, which when executed by the processor, further cause the processor to:
in response to the second syntax element having a second value different than the first value, determine the lifting offset applied to lifting transform values is not enabled.

10. The decoder of claim 6, wherein, in response to the lifting offset applied to the lifting transform values being enabled, for the level-of-detail, to decode the bitstream based on the lifting offset numerator value and the lifting offset denominator value, the memory storing instructions, which when executed by the processor, cause the processor to:
decode a base-mesh displacement from the bitstream based on the lifting offset numerator value and the lifting offset denominator value.

11. A method of encoding by an encoder, comprising:
encoding, by a processor, a first syntax element to determine which type of lifting transform is enabled;
in response to a linear lifting transform being enabled, encoding, by the processor, a second syntax element to determine whether a lifting offset applied to lifting transform values is enabled; and
in response to the lifting offset applied to the lifting transform values being enabled, for a level-of-detail,
encoding, by the processor, a third syntax element to determine a lifting offset numerator value;
encoding, by the processor, a fourth syntax element to determine a lifting offset denominator value; and
encoding, by the processor, a bitstream based on the lifting offset numerator value and the lifting offset denominator value.

12. The method of claim 11, wherein:
the first syntax element indicates which type of lifting transform is enabled,
the second syntax element indicates whether a lifting offset applied to the lifting transform values is enabled,
the third syntax element indicates the lifting offset numerator value, and
the fourth syntax element indicates the lifting offset denominator value.

13. The method of claim 11, wherein, in response to a linear lifting transform being enabled, the encoding, by the processor, the second syntax element to determine whether the lifting offset applied to lifting transform values is enabled comprises:
in response to the second syntax element having a first value, determining, by the processor, the lifting offset applied to the lifting transform values is enabled.

14. The method of claim 13, wherein, in response to a linear lifting transform being enabled, the encoding, by the processor, the second syntax element to determine whether the lifting offset applied to lifting transform values is enabled comprises:
in response to the second syntax element having a second value different than the first value, determining, by the processor, the lifting offset applied to lifting transform values is not enabled.

15. The method of claim 11, wherein, in response to the lifting offset applied to the lifting transform values being enabled, for the level-of-detail, the encoding, by the processor, the bitstream based on the lifting offset numerator value and the lifting offset denominator value comprises:
encoding, by the processor, a base-mesh displacement from the bitstream based on the lifting offset numerator value and the lifting offset denominator value.
